(19) United States
(12) Patent Application Publication
(10) Pub. No.: US 2005/0277107 A1
(43) Pub. Date: Dec. 15, 2005

(54) Systems and methods for cell preservation

(76) Inventors: Mehmet Toner, Wellesley, MA (US); Jason Acker, Spruce Grove (CA); Tani Chen, Acton, MA (US); Alex Fowler, South Dartmouth, MA (US); John M. Baust, Vestal, NY (US); Sankha Bhowmick, Norton, MA (US)

Correspondence Address: WOLF GREENFIELD & SACKS, PC;FEDERAL RESERVE PLAZA, 600 ATLANTIC AVENUE, BOSTON, MA, 02210-2211, US

(21) Appl. No.: 11/035,419

(22) Filed: Jan. 13, 2005

Related U.S. Application Data
(63) Continuation of application No. PCT/US03/23553, filed on Jul. 28, 2003.
(60) Provisional application No. 60/398,964, filed on Jul. 26, 2002.
(60) Provisional application No. 60/398,921, filed on Jul. 26, 2002.

(51) Int. Cl. A01N 1/02

(52) U.S. Cl. 435/2

(57) ABSTRACT

The present invention generally relates to devices and methods for the preservation of cells using drying, freezing, and other related techniques. In one set of embodiments, the invention allows for the preservation of cells in a dried state. In another set of embodiments, the invention allows for the preservation of cells within a glass or other non-viscous, non-frozen media. In some embodiments, the invention allows for the preservation of cells at temperatures below the freezing point of water, and in some cases at cryogenic temperatures, without inducing ice formation. The cells, in certain embodiments, may be preserved in the presence of intracellular and/or extracellular carbohydrates (which may be the same or different), for example, trehalose and sucrose. Carbohydrates may be transported intracellularly by any suitable technique, for example, using microinjection, or through non-microinjected methods such as through pore-forming proteins, electroporation, heat shock, etc. In certain instances, the glass transition temperature of the cells may be raised, e.g., by transporting a carbohydrate intracellularly. In some cases, the cells may be dried and/or stored, for example, in a substantially moisture-saturated environment or a desiccating environment. The cells may also be stored in a vacuum or a partial vacuum. The cells may be protected from oxygen, moisture, and/or light during storage. In certain cases, an inhibitor, such as a cell death inhibitor, a protease inhibitor, an apoptosis inhibitor, and/or an oxidative stress inhibitor may be used during preservation of the cells. The cells may be stored for any length of time, then recovered to a viable state, e.g., through rehydration, for further use.

### RELATED APPLICATIONS

This application is a continuation of International Application No. PCT/US03/23553 filed Jul. 28, 2003, which was published under PCT Article 21(2) in English, which claims priority to U.S. Application Ser. No. 60/398,964, filed Jul. 26, 2002, and U.S. Application Ser. No. 60/398,921, filed Jul. 26, 2002. All of the above-referenced applications are hereby incorporated by reference.

### FEDERALLY SPONSORED RESEARCH

This invention was sponsored by the NIH, Grant No. RO1K46270. This invention was also sponsored by DARPA, Grant No. N00173-01-1 G011. The Government may have certain rights to this invention.

### BACKGROUND

1. Field of Invention

This invention generally relates to the preservation of cells and, in particular, to the preservation of cells using drying and related techniques.

2. Discussion of Related Art

A critical need exists in biotechnology and medicine for the long-term stable storage of cells. Preserved cells are needed in many areas including the banking of nerve, stem and pancreatic islet cells used in cell transplantation and cell-based therapies, diagnostic therapeutic and biosensing applications that depend on the presence of specific lines of cells, the storage of large libraries of transgenic plants and animal reproductive cells, the protection of endangered species by the banking of genomic material, and the use of stored cells as pharmaceutical delivery vehicles which can be easily stored on a shelf until needed.

In most laboratories, mammalian cells are preserved by storage at ultra low temperatures (e.g., less than about −196° C.) in the presence of high concentrations of toxic cryoprotectants such as dimethyl sulfoxide. While cryopreservation has been successfully applied to a number of cell types, the requirement for specialized equipment and detailed freezing protocols has restricted its application. Additionally, the toxicity of many cryoprotectants remains an issue.

### SUMMARY OF INVENTION

This invention generally relates to the preservation of cells using drying and other related techniques. The subject matter of this application involves, in some cases, interrelated products, alternative solutions to a particular problem, and/or a plurality of different uses of a single system or article.

In one aspect, the invention comprises a method. In one set of embodiments, the method includes the steps of inserting a non-permeating agent into a nucleated cell without using microinjection, drying the cell to a moisture content of less than about 30%, and storing the cell, in a substantially constant environment, such that the cell is recoverable in a viable state. The method, according to another set of embodiments, includes the steps of inserting a non-permeating agent into a nucleated cell without using microinjection, and storing the cell for at least about two days, while inducing substantially no ice formation, in a substantially constant environment having at a temperature that is less than about 37° C. and greater than the boiling point of nitrogen, such that the cell is recoverable in a viable state. In yet another set of embodiments, the method includes the steps of inserting a non-permeating agent into a nucleated cell without using microinjection, allowing the non-permeating agent to form a glass internally of the cell, and storing the cell in a substantially constant environment having a temperature less than about 37° C. and greater than the boiling point of nitrogen, such that the cell is recoverable in a viable state.

In one set of embodiments, the method includes the steps of exposing a cell to a cell death inhibitor and/or an oxidative stress modulator, forming a glass internally and/or externally of the cell, and storing the cell in a substantially constant environment having at a temperature less than about 37° C.

The method, according to another set of embodiments, includes a step of storing, in a substantially constant environment, a non-viscous, substantially non-crystalline medium comprising a nucleated cell recoverable in a viable state.

In yet another set of embodiments, the method is defined, at least in part, by the steps of inserting a carbohydrate into a cell to produce an intracellular carbohydrate at a first concentration, forming a glass comprising the carbohydrate at a second concentration around the cell, and storing the cell in a substantially constant environment. In still another set of embodiments, the method includes the steps of inserting a first carbohydrate into a cell, forming a glass comprising a second carbohydrate around the cell, and storing the cell in a substantially constant environment. In one set of embodiments, the method includes the steps of inserting a carbohydrate into a cell in an amount such that the carbohydrate increases the intracellular glass transition temperature by at least about 50° C., and storing the cell in a dried state in a substantially constant environment. The method, in another set of embodiments, includes the steps of inserting a carbohydrate into a cell in an amount such that the carbohydrate increases the intracellular glass transition temperature to at least about 100° C., and storing the cell in a dried state in a substantially constant environment.

In one set of embodiments, the method includes a step of rehydrating a dried non-microinjected nucleated cell to produce a viable cell. According to another set of embodiments, the method includes a step of rehydrating a glass comprising a dried nucleated cell to produce a viable cell. In yet another set of embodiments, the method includes the step of inserting a dried cell into a subject, the cell recoverable in a viable state. The method, in still another set of embodiments, includes a step of placing a dried nucleated cell on a portion of a device such that the cell is recoverable in a viable state. In another set of embodiments, the method includes a step of shipping a recoverable dried nucleated cell. According to yet another set of embodiments, the method includes a step of growing a multicellular organism from a dried non-microinjected cell. According to still another set of embodiments, the method includes a step of owing a multicellular organism from a glass comprising a dried cell. The method, in still another set of embodiments, includes a step of determining a condition of a dried nucleated cell, the cell recoverable in a viable state.

According to another set of embodiments, the method includes the steps of inserting a cell death inhibitor and/or an oxidative stress modulator into a cell, and drying the cell. The method, in yet another set of embodiments, is defined by the steps of laminarly flowing a desiccated gas over a nucleated cell, and recovering the cell in a viable state.

In another set of embodiments, the method includes a step of determining recoverability of a dried cell by examining a humidity indicator. According to yet another set of embodiments, the method is defined, at least in part, by a step of applying a reduced pressure to a dried, recoverable cell.

The invention, in another aspect, comprises an article. In one set of embodiments, the article includes a glass having a temperature less than about 37° C. In some cases, the glass includes a cell and a cell death inhibitor. The article, in another set of embodiments, includes a dried cell and an oxygen-resistant membrane in fluidic communication with the cell.

In one set of embodiments, the article includes a non-microinjected nucleated cell having a moisture content of less than about 30%, where the cell is recoverable in a viable state. The article, in another set of embodiments, includes a non-microinjected nucleated cell, substantially free of ice, stored for at least about two days at a temperature that is less than about 37° C. and greater than the boiling point of nitrogen, where the cell is recoverable in a viable state. In still another set of embodiments, the article comprises a non-microinjected nucleated cell stored at a temperature less than about 37° C. and greater than the boiling point of liquid nitrogen, where the cell contains an intracellular glass and is recoverable in a viable state. In one set of embodiments, the article comprises a glass having a temperature less than about 37° C. and greater than the boiling point of nitrogen, where the glass comprises a nucleated cell recoverable in a viable state. According to another set of embodiments, the glass includes a glass having a temperature less than about 37° C., where the glass comprises a cell and an oxidative stress modulator.

The article, in another set of embodiments, includes a cell comprising an oxidative stress modulator and/or a cell death inhibitor, where the cell stored for at least about a day at a temperature less than about 37° C. In some cases, the cell may be recoverable in a viable state.

In one set of embodiments, the article includes a non-viscous, substantially non-crystalline medium comprising a nucleated cell, where the cell recoverable in a viable state. According to another set of embodiments, the article is defined, at least in part, by a glass comprising a carbohydrate at a first concentration, where the glass further comprises a cell containing the carbohydrate at a second concentration. In yet another set of embodiments, the article comprises a glass comprising a first carbohydrate, where the glass further comprises a cell containing an intracellular glass comprising a second carbohydrate.

The article, according to yet another set of embodiments, includes a dried, recoverable cell containing an intracellular carbohydrate, such that the cell has an intracellular glass transition temperature that is at least about 50° C. greater than the intracellular glass transition temperature in the absence of the intracellular carbohydrate. In still another set of embodiments, the article is defined, at least in part, by a dried, recoverable cell having an intracellular glass transition temperature that is at least about 100° C. The article, in one set of embodiments, includes a carbohydrate at a concentration able to preserve a cell in a dried state when the carbohydrate is inserted into the cell, and a cell death inhibitor and/or an oxidative stress modulator.

In another set of embodiments, the article includes a dried cell, and a membrane in fluidic communication with the cell. In one embodiment, the membrane may be moisture-resistant. In another embodiment, the membrane may be light-resistant.

In yet another set of embodiments, the article includes a dried cell, and an oxygen absorber in fluidic communication with the cell. The article, in another set of embodiments, includes a dried cell and a humidity indicator.

The invention, according to another aspect is defined (at least in part) by a kit. According to one set of embodiments, the kit includes a carbohydrate able to preserve a nucleated cell in a dried state when the carbohydrate is inserted into the cell, and a cell death inhibitor and/or an oxidative stress modulator.

In another aspect, the invention includes a system. The system, according to one set of embodiments, comprises a source of reduced pressure, and at least one cell storage chamber having a volume of less than about 100 mm³ in fluid communication with the source of vacuum.

Other advantages and novel features of the invention will become apparent from the following detailed description of various non-limiting embodiments of the invention when considered in conjunction with the accompanying figures. In cases where the present specification and a document incorporated by reference include conflicting disclosure, the present specification shall control.

### BRIEF DESCRIPTION OF DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For the purposes of clarity, not every component is labeled in every figure, nor is every component of each embodiment of the invention shown where illustration is not necessary to allow those of ordinary skill in the art to understand the invention. In the figures:

FIGS. 1A-1F are photocopies of cells dried in accordance with one embodiment of the invention;

FIGS. 2A and 2B are graphs of membrane integrity and cell growth as a function of moisture content for a hypertonic solution in an embodiment of the invention;

FIGS. 3A and 3B are graphs of membrane integrity and cell growth as a function of moisture content for an isotonic solution in another embodiment of the invention;

FIG. 4 is a graph of the membrane integrity and cell growth after drying of the cells to about 10% moisture content in one embodiment of the invention;

FIG. 5 illustrates membrane integrity as a function of time for dried cells in another embodiment of the invention;

FIG. 6 illustrates Western blot analysis of Bax and Bcl-2 proteins after drying, in accordance with an embodiment of the invention;

FIG. 7 illustrates the analysis of caspases 9 and 6 after rehydration following drying, in accordance with one embodiment of the invention;

FIG. 8 illustrates the analysis of caspases 3 after rehydration following drying, in accordance with another embodiment of the invention;

FIG. 9 illustrates cell viability after drying and rehydration of hepatic cells in one embodiment of the invention;

FIG. 10 illustrates cell viability after drying and rehydration of fibroblasts in another embodiment of the invention;

FIGS. 11A and 11B illustrate drying apparatuses in accordance with certain embodiments of the invention;

FIGS. 12A and 12B illustrate the controlled drying of cells according to another embodiment of the invention; and

FIGS. 13A-13C illustrate various drying apparatuses in accordance with another embodiment of the invention.

### DETAILED DESCRIPTION

The present invention generally relates to devices and methods for the preservation of cells using drying, freezing, and other related techniques. In one set of embodiments, the invention allows for the preservation of cells in a dried state. In another set of embodiments, the invention allows for the preservation of cells within a glass or other non-viscous, non-frozen media. In yet another set of embodiments, the invention allows for the preservation of cells at temperatures below the freezing point of water, and in some cases at cryogenic temperatures, without inducing ice formation. The cells, in some aspects of the invention, may be preserved in the presence of intracellular and/or extracellular carbohydrates (which may be the same or different), for example, trehalose and sucrose. Carbohydrates may be transported intracellularly by any suitable technique, for example, using microinjection, or through non-microinjected methods such as through pore-forming proteins, electroporation, heat or osmotic shock, etc. In certain instances, the glass transition temperature of the cells may be raised in some fashion, e.g., by transporting a carbohydrate intracellularly. In some cases, the cells may be dried and/or stored, for example, in a substantially moisture-saturated environment, or in a desiccating environment. The cells may also be stored, in one set of embodiments, in a vacuum or a partial vacuum. The cells may be protected from oxygen, moisture, and/or light during storage in certain embodiments of the invention. In certain cases, an inhibitor, such as a cell death inhibitor, a protease inhibitor, an apoptosis inhibitor, and/or an oxidative stress inhibitor may be used during preservation of the cells. The cells may be stored for any length of time, then recovered to a viable state, e.g., through rehydration, for further use. In some cases, the cells may also be used or manipulated while in a stored state, e.g., shipped, analyzed, incorporated into devices, etc.

The following applications are incorporated herein by reference in their entirety: U.S. Provisional Patent Application Ser. No. 60/398,964, filed Jul. 26, 2002, entitled “Stable Storage of Desiccated Mammalian Cells in Sugar Glasses,” by M. Toner, et al.; and U.S. Provisional Patent Application Ser. No. 60/398,921, filed Jul. 26, 2002, entitled “Apoptosis Inhibitors in Desiccation Tolerance,” by J. M. Baust, et al. Additionally, the following applications are also incorporated herein by reference in their entirety: U.S. patent application Ser. No. 09/798,327, filed Mar. 2, 2001, entitled “Microinjection of Cryoprotectants for Preservation of Cells,” by M. Toner, et al.; U.S. patent application Ser. No. 09/859,105, filed May 16, 2001, entitled “Microinjection of Cryoprotectants for Preservation of Cells,” by M. Toner, et al.; and International Patent Application No. PCT/US01/15748, filed May 16, 2001, entitled “Microinjection of Cryoprotectants for Preservation of Cells,” by M. Toner, et al.

The following journal articles are incorporated herein by reference in their entirety: T. Chen, et al., “Beneficial Effect of Intracellular Trehalose on the Membrane Integrity of Dried Mammalian Cells,” Cryobiology, 43:168-181 (2001); and J. Acker, et al., “Survival of Desiccated Mammalian Cells: Beneficial Effects of Isotonic Media,” Cell Preservation Technology, 1:129-140 (2002).

As used herein, the term “determining” generally refers to the analysis of a species (e.g., a molecule, cell, etc.), for example, quantitatively or qualitatively, or the detection of the presence or absence of the species. “Determining” may also refer to the analysis of an interaction between two or more species, for example, quantitatively or qualitatively, or by detecting the presence or absence of the interaction.

The term “cell,” as used herein, is given its ordinary meaning as used in biology. The cell may be an isolated cell, a cell aggregate, or a cell found in a cell culture, in a tissue construct containing cells, or the like. A “cell,” as used herein, does not refer to a cell that is an inherent part of a living multicellular organism. Examples of cells include, but are not limited to, a bacterium or other single-cell organism, a eukaryotic cell, a plant cell, or an animal cell. If the cell is an animal cell, the cell may be, for example, an invertebrate cell (e.g., a cell from a fruit fly), a fish cell (e.g., a zebrafish cell), an amphibian cell (e.g., a frog cell), a reptile cell, a bird cell, or a human or non-human mammal, such as a monkey, ape, cow, sheep, big-horn sheep, goat, buffalo, antelope, oxen, horse, donkey, mule, deer, elk, caribou, water buffalo, camel, llama, alpaca, rabbit, pig, mouse, rat, guinea pig, hamster, dog, or cat. If the cell is from a multicellular organism, the cell may be from any part of the organism. For instance, if the cell is from an animal, the cell may be a cardiac cell, a fibroblast, a keratinocyte, a heptaocyte, a chondracyte, a neural cell, a osteocyte, a muscle cell, a blood cell, an endothelial cell, an immune cell (e.g., a T-cell, a B-cell, a macrophage, a neutrophil, a basophil, a mast cell, an eosinophil), a stem cell, etc. Other cells include those from the bladder, brain, esophagus, fallopian tube, intestines, gallbladder, kidney, liver, lung, ovaries, pancreas, prostate, spinal cord, spleen, stomach, testes, thymus, thyroid, trachea, ureter, urethra, or uterus. Other examples of cells include differentiated cells, such as epithelial cells, epidermal cells, hematopoietic cells, melanocytes, erythrocytes, macrophages, monocytes, oocytes, and sperm cells; and undifferentiated cells, such as embryonic, mesenchymal, or adult stem cells. In some cases, the cell may be a genetically engineered cell; in other cases, the cell is not genetically engineered.

In one aspect, the cell is a nucleated cell, and/or a eukaryotic cell. A “nucleated cell,” as used herein, is a cell having a nucleus defined by a nucleic membrane and containing genetic material. Similarly, as used herein, a “eukaryotic cell” typically has (or is derived from a cell having) a nucleus, containing genetic material, surrounded by a nuclear membrane. Eukaryotic cells arise from eukaryotic organisms, e.g., insects, fish, reptiles, amphibians, birds, mammals, humans, etc.

As used herein, a cell is “viable” or in a “viable state” if the cell is able to perform normal or active physiological functions or activities for that type of cell. Examples of normal physiological functions that can be readily identified by those of ordinary skill in the art and include, but are not limited to, metabolism of certain substrates, synthesis of certain proteins, migration, mitosis, differentiation, etc. Those of ordinary skill in the art will be able to identify specific test(s) and/or assay(s) for determining the viability of any given cell or cell type.

As used herein, terms such as “storing” and “storage” refers to the placing of cells under relatively constant and/or ambient conditions for extended periods of time, for example, for at least about one hour, at least about one day, at least about two days, at least about three days, at least about four days, at least about five days, at least about one week, at least about two weeks, at least about four weeks, at least about three months, at least about six months, at least about one year, at least about two years, or even longer in some cases, without making use of their viability, e.g., without rehydrating or otherwise activating the cells. The cells are typically in the dormant, non-physiologically active state during storage (e.g., in a dried state, a frozen state, etc.). Typically, during storage, cells stored under relatively constant and/or ambient conditions are left undisturbed or are only minimally disturbed (e.g., the cells may be moved from one location to another, the temperature may fluctuate around a setpoint, etc.). For example, the cells may be kept in a relatively controlled environment, i.e., an environment where control is maintained over at least one factor within the environment, such as temperature, relative humidity, pressure, light intensity, oxygen concentration, CO₂ concentration, etc. For example, if the temperature is to be controlled during storage (e.g., at a certain setpoint), the cells may be kept in a liquid nitrogen freezer (e.g., a freezer that is cooled using liquid nitrogen, i.e., at a temperature of about −196° C.), a −80° C. freezer, a conventional freezer (e.g., that maintains an environment of roughly −10° C.), a refrigerator (e.g., about 4° C.), an incubator (e.g., at body temperature, about 37° C.), a (heated) water bath, or the like.

As used herein, “ambient conditions” refers to conditions in which a cell (or a medium containing the cell) is exposed to an external environment, for example, to the air inside a building.

The term “dried” and similar terms, as used herein in reference to cells, refer to conditions in which the cells are in a state where the water or moisture content within the cell is insufficient for the cells to maintain normal or active physiological functions or activities, for example, oxidative respiration, metabolism of substrates, protein synthesis, migration, mitosis, differentiation, DNA synthesis and/or repair, and the like. For example, in some cases, the cells may be dried until the cells have a moisture content of less than about 50%, in some cases less than about 30%, in other cases less than about 25%, in other cases less than about 20%, and in still other cases less than about 15%, and in still other cases less than about 10%. In some cases, some residual moisture may remain, for example, greater than about 1%, greater than about 3% or greater than about 5% moisture. It is to be noted that a “dried” cell is not in itself “viable”, but can be restored to a viable state under certain conditions, as described more fully below.

As used herein, the “moisture content” of a sample refers to the relative fraction of water contained in the sample. The water within the sample may be present in any form, i.e., as a solid, a glass, or a liquid. For example, with respect to cells, as used herein, the moisture content is expressed as a percentage of dry weight of the cell, which can be determined using any acceptable technique that can unambiguously quantify the amount of water present within a cell, as is known to those of ordinary skill in the art. Examples of determining the moisture within a cell include heating the cell for a predetermined period of time at a temperature that is able to drive off any residual water present, e.g., at a temperature of about 105-110° C.

As used herein, terms such as “recoverable” and “recovery” refer to the process of restoring dried cells to an active viable state, i.e., from a dried state to a viable state where the cell can perform normal or active physiological functions or activities, as previously described. Examples of recovery processes are further described below.

The term “glass,” as used herein when referring to materials, is given its ordinary meaning as used in the art, i.e., a material, not having a regular crystal structure, that is able to indefinitely maintain a defined shape. A glass typically does not have flow characteristics or properties, unlike a liquid or a rubber. Typically, a glass can be characterized by a glass transition temperature (T_{g}). It should be noted, however, in a few instances herein, the term “glass” is used to mean ordinary (SiO₂) glass, typically when referring to common pieces of laboratory equipment such as glass slides or glass cover slips. In those instances, the correct meaning of the term “glass” will be clear from the context.

A “sugar glass” or a “carbohydrate glass” is a glass that comprises a carbohydrate. As used herein, a “sugar” or a “carbohydrate” is given its ordinary meaning as used in the field of biochemistry. Typically, a carbohydrate is an organic monomer (or a polymer thereof, or a derivative thereof), where the monomers are typically aldehydes and/or ketones generally having an empirical formula (CH₂O)ₙ, where n is usually at least 3. Polymers of such monomers generally are formed through condensation reactions where water (H₂O) is given off. In some cases, a carbohydrate monomer may have an internal ring structure. Examples of carbohydrates that may be suitable in the invention include, but are not limited to, erythrose, threose, erythriol, thyminose (deoxyribose), ribulose, xylose, arabinose, lyxose, ribose, arabitol, ribitol, xylitol, methyl riboside, methyl xyloside, quinovose (deoxyglucose), fucose (deoxygalactase), rhamnose (deoxymannose), talose, idose, psicose, altrose, glucose, gulose, fructose, galactose, allose, sorbose, mannose, tagatose, inositol, mannitol, galactitol, sorbitol, 2-O-methyl fructoside, beta-1-O-methyl glucoside, 3-O-methyl glucoside, 6-O-methyl galactoside, alpha-1-O-methyl glucoside, 1-O-methyl galactoside, 1-O-methyl mannoside, 1-O-ethyl glucoside, 2-O-ethyl fructoside, 1-O-ethyl galactoside, 1-O-ethyl mannoside, glucoheptose, mannoheptulose, glucoheptulose, perseitol (mannoheptitol), 1-O-propyl glucoside, 1-O-propyl galactoside, 1-O-propyl mannoside, 2,3,4,6-O-methyl glucoside, isomaltulose (palatinose), nigerose, cellobiulose, isomaltose, sucrose, gentiobiose, laminaribiose, turanose, mannobiose, melibiose, lactulose, maltose, maltulose, trehalose, cellobiose, lactose, maltitol, isomaltotriose, panose, raffinose, maltotriose, nystose, stachyose, maltotetraose, maltopentaose, alpha-cyclodextrin, maltohexaose, and maltoheptaose.

Other carbohydrates include those that have been modified (e.g., where one or more of the hydroxyl groups of the carbohydrates are replaced with halogen, alkoxy moieties, aliphatic groups, or are functionalized as ethers, esters, amines, or carboxylic acids). Examples of modified carbohydrates include alpha- or beta-glycosides such as methyl alpha-D-glucopyranoside or methyl beta-D-glucopyranoside; N-glycosylamines; N-glycosides; D-gluconic acid; D-glucosamine; D-galactosamine; and N-acteyl-D-glucosamine. In some embodiments, the carbohydrate is an oligosaccharide that includes at least 10, 25, 50, 75, 100, 250, 500, 1000, or more monomers. The carbohydrate may consist of identical (or nearly identical) monomers or a combination of different monomers. Examples of other such carbohydrates include, but are not limited to, hydroxylethyl starch, dextran, cellulose, cellobiose, and glucose. Other suitable carbohydrates include compounds that contain a sugar moiety that may be hydrolytically cleaved to produce a sugar. Still other suitable carbohydrates include glycoproteins and glycolipids.

A “viscous” material, as used herein, generally refers to a material that is able to flow or otherwise alter its shape under ambient conditions. In one aspect, a viscous material is a material having a viscosity of at least about 10¹² or 10¹³ cP (centipoise).

A “frozen” or a “solid” material, as used herein, is given its ordinary meaning as used in the art, i.e., a material having a regular defined crystal structure. A solid material is able to indefinitely maintain a defined shape, and can be characterized by a melting temperature (Tₘ).

The present invention generally relates to devices and methods for the preservation of cells using drying, freezing, and other related techniques. Typically, the cells are prepared by inserting carbohydrates and/or other substances that facilitate cell preservation intracellularly and/or by exposing the cell to the carbohydrates and/or other substances. After the cells have been prepared, the cells may be dried and/or cooled using any suitable method, then stored for any desired length of time, preferably in a controlled environment, or used in some fashion. The cells may then be recovered to return the cells to a viable state, for example, through rehydration. For instance, one aspect of the invention provides for the use of stored cells, for example, for long-term storage, for shipment, for analysis, etc. In one set of embodiments, dried cells may be used in the long-term storage of cells for medical or biological applications. For example, cells such as stem cells and the like may be dried and stored before use. Specific examples include the storage of organ cells, cell lines, pancreatic islet cells, hepatocytes, nerve cells, and the like. Other examples of using stored cells include the construction and/or storage of devices such as biomedical devices or biosensor devices containing cells, genome resource banking of plant and animal cells such as reproductive cells (for example, transgenic cells), and/or the storage of cells used as pharmaceuticals and/or pharmaceutical delivery vehicles. As one particular example, a stored, dried cell may be inserted into a subject for example, as a medicament or a prophylactic treatment. As another example, a stored cell may be recovered and grown or cloned to form a multicellular organism, for example, if the cell is a sperm cell or an egg cell, or a cell suitable for cloning. As yet another example, a dried cell may be shipped, from one location to another, preferably without the need for refrigeration equipment or the need to maintain the cell in a frozen state.

In another set of embodiments, a dried cell may be analyzed, for example, to determine a physical property of the cell. For example, a dried cell may be analyzed using any suitable analytical technique, for example spectroscopy, electron microscopy, or the like. In another example, a dried cell may be sectioned or fractionated in some fashion to permit analysis to occur, for example, internally of the cell.

Another aspect of the present invention provides for the inserting or injecting a carbohydrate (or a mixture thereof) into a cell that facilitates preservation of the cell during storage of the cell, for example, in a dried and/or glassy state. Any suitable non-lethal intracellular delivery technique may be used to insert the carbohydrate. The exact intracellular delivery technique used will be a function of the carbohydrate to be delivered, as well as the type of cell(s) to be preserved, and can be chosen by those of ordinary skill in the art. Examples of suitable non-lethal delivery techniques include microinjection techniques, as well as non-microinjection techniques such as delivery using pore-forming proteins and other entities, electroporation, heat or osmotic shock, liposomal delivery, sonication, ultrasound, thermatropic phase transitions, and the like. Specific examples follow.

In microinjection, a substance is injected into a cell by means of a capillary tube that is used to penetrate the plasma membrane of the cell. As used herein, a “microinjected cell” is a cell that has been mechanically penetrated by a capillary or other microscopic object(s), and a substance has been introduced into the cell. Typically, the capillary tube is used to deliver a substance that ordinarily is not able to significantly permeate across the plasma membrane into the cell at levels able to affect the cell (a “non-permeating agent”), for example, carbohydrates and/or carbohydrate derivatives such as those described herein. The capillary tube typically has a diameter on the order of microns to nanometers, and is often made from glass. Those of ordinary skill in the art can identify suitable non-lethal microinjection techniques for delivering a specific carbohydrate into a specific cell. Examples of suitable microinjection techniques are described in International Patent Application No. PCT/US01/15748, filed May 16, 2001, entitled “Microinjection of Cryoprotectants for Preservation of Cells,” by M. Toner, et al; and in Nakayama and Yanagimachi, “Development of normal mice from oocytes injected with freeze-dried spermatozoa,” Nature Biotech., 16:639-642, 1998, each of which is incorporated herein by reference.

Non-limiting examples of non-microinjection delivery methods include delivery using pore-forming proteins and other entities, electroporation, heat or osmotic shock, liposomal delivery, sonication, ultrasound, thermatropic phase transitions, and the like. In such methods, a substance is typically introduced artificially (i.e., not through normal cellular uptake processes) through a method that does not involve microinjection. For example, the substance may be introduced by an experimental protocol performed by a human, or through automated or mechanical means. In some cases, a microinjected cell can be distinguished from a non-microinjected cell through the use of certain techniques known to those of ordinary skill in the art, for example, through volumetric changes, or via the injection of a fluorescent probe. Thus, examination of a cell, using such techniques, may be used to determine whether a cell has been microinjected.

An example of a non-microinjection technique suitable for use in the invention is the use of a pore-forming protein or other pore-forming entity to create a transport pathway for the delivery of carbohydrates and other substances intracellularly. In some cases, the pore-forming entity may be one that can be controlled in some fashion, for instance, the pore (i.e., the opening within the cell, typically of nanometer dimensions) created by the pore-forming entity may be opened or closed at will, or the size (effective diameter) of the pore may be altered as necessary. The exact parameters used to produce pores within the cell for the intracellularly delivery of carbohydrates at a certain target level, using the pore-forming entity, can be chosen by those of ordinary skill in the art.

One example of a pore-forming protein is alpha-hemolysin, which is produced in Staphylococcus aureus; other suitable pore-forming proteins can be identified by those of ordinary skill in the art. In certain cases, the pore-forming protein may be genetically engineered in some fashion to confer additional traits to the protein, e.g., to facilitate control of pore formation, or to facilitate delivery of the carbohydrate or other substance to a cell. For example, alpha-hemolysin may be genetically engineered to include a moiety that can bind reversibly to zinc or other divalent cations, where the binding of a zinc ion or other divalent cation to alpha-hemolysin may close or at least partially block the pore One such moiety is a sequence of five consecutive histidine residues, in a genetically engineered form of alpha-hemolysin known as H5. As another example, the moiety may be a moiety responsive to a certain chemical signal or concentration, such that the presence or absence of the chemical may facilitate or inhibit pore formation.

Another example of a suitable non-microinjection technique is electroporation, i.e., the application of electricity to a cell in such a way as to cause the insertion of the carbohydrate or other substance into the cell without killing the cell. Typically, electroporation includes the application of one or more electrical voltage “pulses” having relatively short durations (usually less than 1 second, and often on the scale of milliseconds or microseconds) to a media containing the cells. The electrical pulses typically facilitate the transport of extracellular carbohydrates (or other substances) into a cell. The exact electroporation protocols (such as the number of pulses, duration of pulses, pulse waveforms, etc.), will depend on factors such as the cell type, the cell media, the number of cells, the substance(s) to be delivered, etc., and can be determined by one of ordinary skill in the art.

Other examples of non-microinjection techniques include the application of sonication, typically at ultrasound frequencies, to a media containing cells to facilitate the transport of extracellular carbohydrates (or other substances) into the cells; liposomal delivery and/or other lipid fusion techniques for transporting materials into a cell; phagocytotic delivery methods, or heat or osmotic shock (for example, by manipulating thermatropic phase transitions to cause temporary openings in the plasma membrane of the cell). Those of ordinary skill in the art will be able to identify other suitable non-lethal intracellular delivery techniques for transporting a substance into a cell.

In one aspect, the invention includes a solution that may be delivered into a cell to facilitate the preservation of the cell during storage, for example, in a dried and/or glassy state. In some cases, the solution may include a carbohydrate. In one set of embodiments, the carbohydrate may be any carbohydrate able to form a glass state within the cell, e.g., when the cell is dried and/or during cryopreservation. In some cases, the carbohydrate may cause the glass transition temperature of the cell to increase when delivered intracellularly, for example, by at least about 20° C. or at least about 50° C., or such that the glass transition temperature is at least about 80° C., and in some cases at least about 100° C., at least about 120° C., at least about 140° C., at least about 160° C., or at least about 180° C.

A high intracellular glass transition temperature may be preferable in some cases. For example, a cell may be stored at a temperature below the intracellular glass transition temperature to ensure that the cell is in a glassy state during storage. In some cases, it may be preferred that the cell be stored at a storage temperature significantly below the intracellular glass transition temperature of the cell, for example, a storage temperature of at least about 30° C., at least about 50° C., or at least about 80° C. or more below the glass transition temperature. A higher intracellular glass transition temperature may allow storage of the cells under less extreme or warmer conditions. For example, in certain cases where the intracellular glass transition temperature is sufficiently high, the cell may be stored at −80° C., within a conventional freezer or refrigerator (about −10° C. or about 4° C., respectively), or even at room temperature (about 25° C.), instead of in liquid nitrogen.

When a carbohydrate is introduced into a cell to facilitate preservation, an intracellular carbohydrate may be chosen due to its ability to protect internal structures of the cell against dehydration-induced or other stresses during storage. Thus, the carbohydrate can be chosen, in some cases, based on its ability to prevent significant changes in the molecular architecture of the cell during storage, for example due to its ability to mimic the structure of water and/or bind to the internal structures of the cell (sometimes referred to in the literature as the “water replacement hypothesis”). One test to determine the ability of an intracellular carbohydrate to protect the internal structure of the cell during storage is to measure the protein structure of a cell in the presence and absence of the intracellular carbohydrate, for example, using techniques such as Fourier transform infrared spectroscopy or mass spectroscopy. Those of ordinary skill in the art will be able to identify other suitable tests for determining if a given carbohydrate has the ability to prevent significant changes in the molecular architecture of the cell during storage of the cell.

Where carbohydrate is used within a cell, the final concentration of carbohydrate within the cell, after delivery, may be about 1.0 M, about 0.6 M, about 0.5 M, about 0.4 M, about 0.3 M, about 0.2 M, about 0.1 M, about 0.05 M, about 0.02 M, or about 0.01 M. Examples of suitable carbohydrates for intracellular delivery include, but are not limited to, trehalose, sucrose, raffinose, glucose, lactose, inositol, etc. In some cases, the carbohydrate may be a disaccharide sugar. In certain cases, trehalose and sucrose may be particularly preferred. Combinations of carbohydrates, for example, trehalose and sucrose, or trehalose and raffinose, may also be used intracellularly in some instances. In certain embodiments, other excipients or stabilizers, for example, glycerol, can also be used in connection with the carbohydrate.

Carbohydrates and/or other substances may be inserted into a cell according to one embodiment of the invention such that the osmolarity of the cell is isotonic or isoosmotic with the external environment surrounding the cell, for example, such that the cell maintains osmotic equilibrium and/or does not undergo excessive shrinking or swelling during loading, storage, and/or rehydration of the cell. For example, the concentration and amount of carbohydrate delivered intracellularly may be such that the cell will be isotonic with the external environment after loading of the cell with the carbohydrate. The exact amount of carbohydrate to be added intracellularly may be determined by those of ordinary skill in the art.

Another aspect of the invention provides for inserting or injecting an inhibitor, such as a cell death inhibitor or an oxidative stress inhibitor, into a cell to facilitate preservation of the cell. The inhibitor may be added along with the carbohydrate or other substance (e.g., using the same insertion technique), or the inhibitor may be added before or after transport of the carbohydrate or other substance intracellularly. Such inhibitors may be useful, for example, in cases where a cell may negatively respond to dehydration or cryopreservation-induced stresses (e.g., resulting in alterations in intracellular osmolarity, oxidative damage, changes in intracellular concentrations of certain species, and the like). In some cases, for example, the cell may respond to such stresses by entering a cell death pathway (e.g., through apoptosis and/or necrosis). Thus, in one set of embodiments, an inhibitor is provided that may inhibit cell death when delivered intracellularly in association with a carbohydrate or other substance, and/or inhibit signaling pathways able to cause the cell to enter a cell death pathway. For instance, in one set of embodiments, the inhibitor may inhibit specific cell death enzymes, for example, a protease inhibitor such as interleukin-1 beta-converting enzyme (ICE)-like protease inhibitor, or apoptosis inhibitors such as alpha-tocopherol, IDUN-1529 or IDUN-1965 (IDUN Pharmaceuticals, San Diego, Calif.). Additional non-limiting examples of protease inhibitors include inhibitors of caspase or calpain, such as Caspase-1 Inhibitor V, Caspase-3 Inhibitor, Caspase-9 Inhibitor, Caspase-8 Inhibitor, Calpain-1 Inhibitor, Calpain-2 Inhibitor, ethylenediaminetetraacetatic acid (“EDTA”), cysteine protease inhibitors, and the like. The inhibitor, in another set of embodiments may be an oxidative stress inhibitor, e.g., a compound able to regulate oxidative stress protein activity within a cell. For example, the oxidative stress inhibitor may be an inhibitor for nitrous oxide synthase. Non-limiting examples of suitable oxidative stress inhibitors include vitamin E, vitamin C, vitamin D, beta carotene (vitamin A), superoxide dismutase, selenium, melatonin, zinc chelators, calcium chelators, and the like.

The final concentration of extracellular carbohydrate after delivery, in certain embodiments, may be about 1.0 M, about 0.6 M, about 0.5 M, about 0.4 M, about 0.3 M, about 0.2 M, about 0.1 M, about 0.05 M, about 0.02 M, or about 0.01 M. Examples of suitable extracellular carbohydrates include, but are not limited to, sucrose, trehalose, dextrans, maltodextrans, poly(vinylpyrrolidones), hydroxyethyl starch, maltohexose, maltopentose, maltotriose, and the like. In some cases, the carbohydrate may be a disaccharide sugar. In certain cases, trehalose and sucrose may be particularly preferred. Combinations of carbohydrates, for example, trehalose and sucrose, or trehalose and raffinose, may also be used extracellularly in some instances. In certain embodiments, other excipients or stabilizers, for example, glycerol, may also be used in connection with the carbohydrate.

In another aspect, the invention includes a solution for surrounding a cell with an extracellular carbohydrate or other substance (or a mixtures thereof) to facilitate the preservation of the cell during storage, e.g., in a dried state and/or in a glass. The extracellular carbohydrate (or other substance) is not required to be bioprotective or biocompatible, although it can be in certain embodiments of the invention. The extracellular substance(s) may or may not be the same as any intracellular substance(s) that may be present (e.g., as previously described); for example, the extracellular carbohydrate and the intracellular carbohydrate with respect to a cell may each be trehalose or sucrose. As a particular non-limiting example, the intracellular carbohydrate may be trehalose and the extracellular carbohydrate may be a mixture of trehalose and raffinose.

In one set of embodiments, if the extracellular solution comprises a carbohydrate, the carbohydrate may have a glass transition temperature that is significantly above room temperature, for example, having a glass transition temperature of at least about 80° C., and in some cases at least about 100° C., at least about 120° C., at least about 140° C., in at least about 160° C., or at least about 180° C. A high extracellular glass transition temperature may be preferable in some cases. For example, the cell may be stored at a temperature below the extracellular glass transition temperature to ensure that the cell remains immobilized in a glassy matrix during storage (dried and/or cooled). A higher extracellular glass transition temperature may allow storage of the cell under less extreme or warmer conditions. For example, in certain cases where the extracellular glass transition temperature is sufficiently high, the cell may be stored at −80° C., within a conventional freezer or refrigerator (about −10° C. or about 4° C., respectively), or even at room temperature (about 25° C.), instead of within liquid nitrogen.

The glass transition temperature of the extracellular carbohydrate mixture, in accordance with another set of embodiments, may be chosen to generally match the glass transition temperature of the cell (which may be modified by the presence of intracellular carbohydrates, in some embodiments of the invention, as previously described). For example, the extracellular carbohydrate may be chosen such that the extracellular glass transition temperature and the intracellular glass transition temperature are within about 20° C., about 10° C., or about 5° C. of each other.

In yet another set of embodiments, the concentration of extracellular carbohydrate or other substance (or mixtures thereof) in a solution is chosen such that the osmolarity of the cells is isotonic or isoosmotic with the external environment surrounding the cell. For example, the concentration(s) may be chosen such that the cell maintains osmotic equilibrium and/or does not undergo excessive shrinking or swelling during loading, storage, and/or rehydration. The exact amount and concentration of extracellular carbohydrate can be determined by one of ordinary skill in the art.

In one aspect of the invention, the cell, after preparation, can be preserved in a dried state and/or in a glass. The glass may be intracellularly and/or extracellularly formed, e.g., a cell in a solution may become embedded within an extracellular glass formed through the drying of the solution to the glass. The intracellular and/or extracellular glass may be formed, in one set of embodiments, by cooling the cell to a temperature less than the intracellular and/or extracellular glass transition temperature. In another set of embodiments, the glass(es) may be formed by removing moisture from the cell and/or the solution containing the cell (“drying”), thereby causing the glass transition temperature to increase, until the glass transition temperature is greater than the temperature of the cell or solution, thus creating conditions in which a glass is able to form. In some cases, the glass thus formed may be stable at room temperature for extended periods of time. In another set of embodiments, a combination of drying and cooling may be used to cause glass formation to occur.

In one set of embodiments, the cell to be stored may be cooled to facilitate glass formation. The cell may be cooled using any suitable cooling technique. For example, the cell may be cooled by exposing the cell to a cold substance such as liquid nitrogen, or by placing the cell in a conventional freezer or a refrigerator. The cell can also be cooled in a lyophilizer according to one embodiment of the invention. Other suitable techniques for cooling cells or media containing cells can be identified by those of ordinary skill in the art. In certain cases, the cells may also be dried, for example, as discussed below.

The cell, in another set of embodiments, may be dried to facilitate glass formation using any suitable drying technique able to remove water from the cell and/or the media containing the cell. Examples of suitable drying techniques include, but are not limited to, natural convection techniques (e.g., air drying or exposure to a desiccant), forced convection techniques (e.g., drying by exposure to a stream of a gas, such as nitrogen), vacuum drying (e.g., exposure to a vacuum), freeze drying or lyophilization, spin drying, spray drying, heating, or the like, as well as combinations of these techniques. Drying may be performed until a certain condition has been reached. For example, the cell may be dried until a glass forms (intracellularly and/or extracellularly) and/or until a certain predetermined final moisture content has been reached. In some cases, drying may also be accompanied by cooling. For example, in some cases, the cell may be dried at a temperature of about 10° C. or about 4° C., or the cell may be dried, then cooled.

Drying of the cell is accomplished in one embodiment through natural convection techniques such as air drying (exposure to ambient air) and/or exposure to a desiccant. If a desiccant is used to control the relative humidity of the air surrounding the cell (or media), the desiccant may be any suitable desiccant that is biologically compatible with cells (for example, the desiccant may be one that is generally non-volatile or otherwise does not affect the cells). The specific desiccant used will be a function of experimental conditions such as the desired relative humidity surrounding the cell, and the drying time, etc., and can be determined by those of ordinary skill in the art. Non-limiting examples of suitable desiccant include solid desiccants such as P₂O₅, CaSO₄, CaCl₂; or solutions of a salt and water, where the solution of salt and water is able to regulate the relative humidity within a closed environment, for example, a salt solution of K₂SO₄, Na₂SO₄, KCl, NaCl, etc.

In another embodiment, the cell may be dried using forced convection, i.e., a stream of gas may be passed across the cell (or the media containing the cell) to facilitate drying thereof. Any biologically compatible gas may be passed across the cell to facilitate drying; for example, gases such as nitrogen, oxygen, carbon dioxide, argon, and the like (as well as combinations of these) may be used to facilitate drying. In some cases, the gas may be desiccated or at least partially desiccated in some fashion before being applied to the cell, e.g., by passing the gas through a column containing a desiccant. The gas can be passed in a laminar fashion across the cells in certain embodiments; in other embodiments, the gas stream can be passed across the cells in a turbulent fashion. In certain embodiments, convection drying may be controlled, depending on the specific application to provide reproducible drying characteristics over a wide range of gas flowrates, which can allow tight control of the final moisture content of the cell during and after drying.

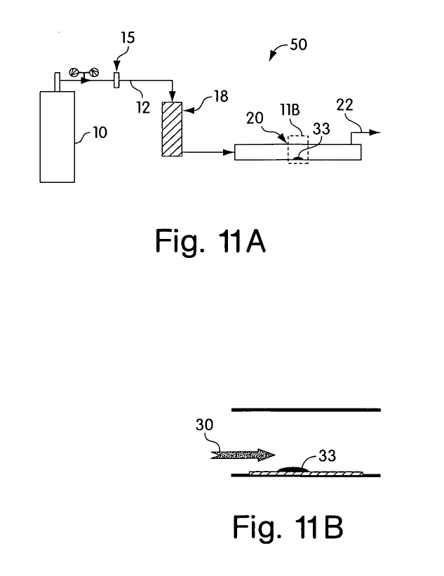

As one example of a forced convective drying system, in FIG. 11A, in drying system 50, a gas from gas source 10 may be used to dry cells 33 within drying chamber 20. Gas source 10 may be any suitable source of gas, for example, a gas cylinder or a reaction vessel. The gas is passed through line 12, optimally through a flowmeter 15 and/or a desiccation column 18, before being passed through drying chamber 20. In some cases, drying chamber 20 may be transparent or at least partially transparent, for example, to allow for monitoring of the drying process of cells 33. From drying chamber 20, the gas is passed through exit line 22, for example, to be released to the atmosphere, recycled, or sent to another chamber. An expanded view of drying chamber 20 in FIG. 11B illustrates the passage of the gas (indicated by arrow 30) over cells 33. As described above, the gas may be passed across cells 33 in a laminar or a turbulent manner, depending on the drying characteristics that are desired.

In yet another embodiment, the cell may be dried using “vacuum drying,” i.e., the cell is exposed to a reduced pressure (i.e., a pressure that is significantly less than atmospheric pressure, but not necessarily a perfect vacuum) to facilitate drying of the cell (or the media containing the cell). A reduced pressure may enhance the removal of water from the cell or cell media. In some cases, a small volume for the chamber containing the cell during vacuum drying may be desired; for example, to minimize the drying time or volume of dead space within the chamber. For example, the volume within the chamber may be less than about 200 mm³, in some cases less than about 100 mm³, in other cases less than about 50 mm³, and in other cases less than about 20 mm³. In some cases, the volume of the chamber is chosen to be of a size that is only slightly larger than the media that contains the cell(s).

In still another embodiment, the cell may be dried using lyophilization, or freeze-drying. Lyophilization and similar related techniques are well-known to those of ordinary skill in the art. In this procedure, generally, the temperature of the cell is lowered to a temperature at which the solution containing and/or within the cell can solidify into a solid or a glass. The pressure surrounding the cell media is reduced and water is removed from the media through sublimation. Suitable freeze-drying (lyophilization) conditions for a particular application may be chosen by those of ordinary skill in the art and may depend on factors such as the volume and composition of the media, the lyophilization temperature (or temperature profile), the vacuum pressure, etc.

Drying of the cell or media containing and/or within the cell, in some embodiments, may be controlled by drying the cell or media on a substrate having certain cell binding properties. For example, a substrate that promotes specific cell adhesion and/or binding may have a different rate of cell drying than cells on a non-specific cell binding substrate or cells within a cell suspension. Examples of substrates having specific cell binding properties able to alter cell drying include, but are not limited to, substrates such as laboratory glass or plastic (e.g. polystyrene), coated with a specific cell-binding protein or marker, such as collagen, fibronectin, laminin, RGD peptides, and the like. As another example, the substrate that the cell is bound to may be part of a tissue construct.

In one set of embodiments, the media containing the cell may be dried until the media forms a non-viscous, non-frozen state including the cells. In one set of embodiments, the non-viscous, non-frozen state thus formed is a glass. Additional steps, such as additional drying and/or cooling of the media, may also occur after the glass has formed. The moisture content at which the glass forms during drying is generally a function of the concentration of carbohydrate(s) within the media, and can be determined by those of ordinary skill in the art. In some cases, the media is dried at least to a point near the glass transition curve of the media, i.e., the media is dried to a point such that the temperature of the media is near the glass transition temperature of the media.

In another set of embodiments, the cell or the media containing the cell is not dried to complete dryness (i.e., to a moisture content of 0%). For example, the media may be dried until a moisture content of about 5% or about 10% is reached (within the media, and/or within the cell), or the media may be dried such that the remaining water present within the cell or media is sufficient to stabilize the proteins and/or lipids of the cell in their native conformations, or at least in conformations similar to their native conformations. In other cases, the cell or cell media may be dried to a moisture content sufficient to prevent degradation and/or other forms of damage from occurring in the cell due to dehydration-induced stresses.

In another aspect of the invention, the cells, after cooling and/or drying has been performed, may be stored under relatively constant and/or ambient conditions for extended periods of time, for example, in an environment generally having controlled temperatures, relative humidities, non-oxidative gases, etc. The cells may be stored under such conditions for any desired length of time, for example, for at least about one day, at least about one week, at least about one month, at least about two months, at least about three months, at least about 6 months, or at least about a year. In some cases, the cells may be stored in environments that discourage water, oxygen, and/or light from interacting with the cells.

For instance, in one set of embodiments, the cells may be stored at a controlled temperature, for example, in a refrigerated environment (e.g., about 4° C.), a freezer (e.g., about −20° C.), a −80° C. freezer, or even at lower temperatures in some cases, for example, at or below the boiling point of nitrogen (about −196° C.). In other embodiments, the cells may be stored at or near room or ambient temperature, i.e., the cells can be stored for extended periods of time without the use of refrigeration equipment and/or liquid nitrogen. In some embodiments, the storage temperature may be a temperature less than the intracellular and/or extracellular glass transition temperature (if applicable). In certain embodiments, the cells may be stored in a glass (i.e., without any ice present) for extended periods of time at a temperature that is below the physiological temperature of the cells, and, in some cases, below the ice nucleation temperature (i.e., the temperature at which ice spontaneously forms from water in the absence of a nucleation agent, about −40° C.).

The cells, in another set of embodiments, may be stored in an environment having a relatively high relative humidity. For example, the relative humidity may be at least about 50%, at least about 80%, at least about 90%, at least about 95%, at least about 97%, and in some cases, at or near 100% relative humidity (i.e., in a saturated environment). Relatively high relative humidities can be useful, for example, in embodiments where the cells are stored in environments where further additional drying of the cells is not desirable.

The cells may be stored in non-oxidative environments in yet another set of embodiments. For example, in one embodiment, the cells are stored in the presence of a non-oxidative gas, i.e., a gas (or a mixture of gases) that is not able to cause oxidative damage to the cells. Non-limiting examples of oxidative gases include gases such as nitrogen, carbon dioxide, noble gases such as argon, etc. In another embodiment, the cells may be stored under vacuum or reduced pressures, i.e., under pressures significantly less than atmospheric pressure, for example, under a pressure of about 0.5 atm, about 0.3 atm, about 0.1 atm, or less in some cases. In certain instances, the pressure surrounding the cells may be due primarily to the vapor pressure of the water, i.e., the environment surrounding the cells has a pressure generally equal to the vapor pressure of water and an effective relative humidity of about 100%. In some embodiments, it may be desired that the volume of the chamber containing the cells during storage be kept small, for example to promote more rapid equilibration of the environment with the cells. For example, the volume of each chamber containing cells may be less than about 200 mm³, in some cases less than about 100 mm³, in other cases less than about 50 mm³, and in other cases less than about 20 mm³. In some cases, the volume of the chamber may be chosen to be a size that is only slightly larger than the media containing the cells.

In still another set of embodiments, an oxygen absorber (i.e., a material able to react or otherwise trap oxygen from the environment) may be placed in fluid communication with the cells during storage, i.e., such that a gas or a liquid can freely move between the cells (or the media containing the cells) and the oxygen absorber. The oxygen absorber may react with or otherwise remove oxygen from the environment, thus inhibiting oxidative damage by oxygen to the cells. Examples of suitable oxygen absorbers include oxygen consumption reactions, such as the reaction of iron powder or other metals with air, oxygen scavenging polymers such as ethylene methylacrylate cyclohexenylmethyl acrylate, and other types of oxygen absorption systems known to those of ordinary skill in the art, for example, oxygen absorber Type B and oxygen absorber Type D, such as are commonly used in the food industry.

In still another set of embodiments, the cells may be stored in an environment able to discourage water, oxygen, and/or light from interacting with the cells. For example, in one embodiment, the cells may be contained within a container that is moisture-resistant and/or oxygen-resistant. For example, the container may be constructed out of moisture-resistant and/or oxygen-resistant materials, such as polyethylene, polyester, Mylar (trademarked by the E. I. Du Pont de Nemours Co. Corp.), etc. In some embodiments, the container may be opaque to discourage light from interacting with the cells. The container may be generally flexible in some cases, for example, having the shape of a “bag” or a “pouch.” In some embodiments, the container may be sealed (e.g., airtight) after the cells have been placed within the container.

In some embodiments, the cells may be stored in fluidic communication with an oxygen-resistant membrane and/or a moisture-resistant membrane, e.g., a membrane constructed out of one or more of the moisture-resistant and/or oxygen-resistant materials previously described.

In another set of embodiments, an indicator able to determine the moisture content or relative humidity of the environment may be placed in fluid communication with the cells during storage. The moisture content or relative humidity may be used to determine the success of storage of the cells, or the degree of recoverability (viability) of the cells after storage. Suitable devices for determining relative humidity are well-known to those of ordinary skill in the art. In one embodiment, the relative humidity may be determined using a humidity plug or a hygrometer, e.g., a digital or solid state hygrometer. In another embodiment, a material able to change its visual or other properties (e.g., color based on relative humidity may be placed in fluid communication with the cells, or within the container containing the cells. Changes in the material (e.g., a color change, for example, from blue to pink) may be used to determine the relative humidity within the container, which may be used to determine the recoverability of the cells. Non-limiting examples of suitable materials able to respond to changes in relative humidity include cobalt chloride and commercially-available humidity indicator cards or strips (which can be reversible or non-reversible). Those of ordinary skill in the art will be able to identify other suitable materials.

The invention also provides for the rehydration of stored cells (e.g., dried and/or cooled) in accordance with another aspect of the invention. In some embodiments, rehydration of cells may be relatively rapid, i.e., a physiologically acceptable solution may be added to a cell to rehydrate it. As used herein, “rapid” refers to a change from a stored environment to an environment in which the cell can be physiologically active. In other embodiments, rehydration may be controlled in some fashion, for example, to minimize any damage that may occur to the cells during rehydration, i.e., the cells may be brought through one or more intermediate environments from the stored environment to an environment in which the cells can be physiologically active. For instance, the temperature, pH, osmotic pressure, composition, etc. during the rehydration process may be controlled in some fashion, for example, continuously or stepwise. For example, the cells may be placed in an environment having a controlled predetermined relative humidity and/or temperature; exposure of the cells to such an environment may cause moisture condensation to occur on the cells to effect rehydration.

In one set of embodiments, the cells may be slowly or rapidly rehydrated in an isotonic medium. The cells may be exposed to an isotonic solution able to maintain osmotic equilibrium of the cells with the surrounding fluid, such that the cells do not undergo excessive shrinkage and/or swelling during rehydration. In some cases, the isotonic medium may be altered (e.g., through changes in concentration and/or osmolarity of the solution, for example continuously or stepwise) as the osmolarity of the cells changes during rehydration.

The invention also includes a kit including any of the above-described compositions and systems, according to another aspect of the invention. As used herein, a “kit” typically defines a package including any of the above-described systems of the invention and instructions of any form that are provided in connection with the invention in a manner such that one of ordinary skill in the art would clearly recognize that the instructions are to be associated with the invention. The instructions can include any oral, written, or electronic communications provided in any manner. The kits described herein may also contain one or more containers containing various components, such as various carbohydrates or other substances, pore-forming entities, media, salts, excipients, etc., separately packaged or packaged in various sub-combinations (e.g., two carbohydrates, a carbohydrate and a pore-forming entity, etc.), as well as instructions for preparing, mixing, or diluting, or administration of the systems of the invention. The compositions in the kit may be provided as liquid solutions or as dried powders. When the compound provided is a dry powder, the powder may be reconstituted by the addition of a suitable solvent (for example, water, saline, cell growth media such as DMEM or RPMI, etc.), which may or may not be provided. Liquid forms of the compositions may be concentrated or ready to use.

In one aspect, the invention includes the promotion of any of the above-described systems. As used herein, “promoted” includes all methods of doing business including methods of education, hospitals, or other clinical instruction, pharmaceutical industry activity including pharmaceutical sales, or any advertising or other promotional activity including written, oral and electronic communication of any form, associated with the systems of the invention, or with instructions clearly recognized to be associated with the systems of the invention.

The following examples are intended to illustrate certain aspects of certain embodiments of the present invention, but do not exemplify the full scope of the invention.

### EXAMPLE 1

This example illustrates various techniques for use in preserving cells in accordance with certain embodiments of the invention.

NIH 3T3 murine fibroblasts were cultured in Dulbecco's Modified Eagle's medium (DMEM) supplemented with 10% v/v bovine calf serum and 1% v/v penicillin-streptomycin at 37° C. with 10% CO₂ in air. At 70% confluence, the cells were trypsinized and resuspended in culture medium. 20 microliter droplets of cells were plated onto sterile 12 mm circular glass cover slips and cultured for 30 min at 37° C. to allow for loose attachment of the fibroblasts to the cover slip. In some cases, poly-L-lysine-coated cover slips were used for attaching the cells to the cover slips. The cover slips were precoated with poly-L-lysine to assure uniform surface characteristics as follows. The cover slips were first prepared by soaking them in aqua regia overnight. The next day, the cover slips were rinsed in 50 mM NaHCO₃, then in de-ionized H₂O. The cover slips were then baked for at least 3 h at 150° C. The cover slips were removed from the oven and floated in a 1 mg/ml solution of poly-L-lysine for 5 min on each side, then rinsed in de-ionized H₂O and air-dried.

Trehalose was inserted into the fibroblasts as follows. The fibroblasts were washed with 30 microliters of a HEPES-buffered saline solution supplemented with EDTA, followed by three washes with 30 microliters of RPMI-1640. The cells were then porated by exposure to an RPMI-1640 solution containing 25 micrograms/ml of a pore-forming protein, H5 alpha-hemolysin, for 10 min. Intracellular trehalose was inserted into the porated cells by exposure to either a hypertonic (RPMI-1640+0.2 M trehalose; 528 mOsm/kg) or an isotonic (RPMI-1640 diluted in H₂O+0.2 M trehalose; 310 mOsm/kg) trehalose solution for 45 min. The pores created by H5 alpha-hemolysin in the fibroblasts were closed by adding 25 micromolar ZnSO₄ to the solution. The fibroblasts were then washed in an (H5-free) hypertonic or an isotonic trehalose solution. The osmolality of the solution was measured using a freezing-point depression osmometer. All experimental manipulations were performed at room temperature, unless otherwise indicated.

An alternate procedure that was used in some cases to insert trehalose into fibroblasts is as follows. The fibroblasts were suspended in DMEM/F12/FBS at 10⁶ cells/ml, and 20 microliters of suspension was pipetted onto a glass cover slip. The cover slip was incubated for 30 min at 37° C., 100% RH under 10% CO₂. The medium was aspirated and replaced with 50 microliters of ethylenediaminetetraacetic acid (EDTA) solution. After about 5 min, the EDTA solution was aspirated and replaced with 50 microliters HEPES-buffered saline (HBS). The solution was aspirated after about 5 min and replaced with 20 microliters of a chilled solution of 25 micrograms/ml of H5 and 5 mM ATP in HBS. The cells were incubated for 15 min. Next, the H5/ATP/HBS solution was aspirated and replaced by 35 microliters of a trehalose/H5/ATP/HBS solution (ranging from 0 to 0.4 M trehalose). The cells were incubated in this solution for 1 h. To close the pores created by H5, 2 microliters of 1 mM ZnSO₄ in HBS was added to the solution containing the cells and incubated for 5 min. This solution was then aspirated and replaced with 20 microliters of a solution of trehalose in DMEM/F12/FBS at a desired loading concentration.

Techniques used in these experiments for drying cells included evaporative drying (using natural convection) or forced laminar convective flow. The natural convection protocol is generally as follows. The approximate pre-desiccation dimensions of the 20 microliter droplet of media containing the fibroblasts on the glass cover slip was 6 mm diameter×1 mm height. The cover slips were placed in airtight acrylic boxes containing CaSO₄/CoCl₂ desiccant. The cover slips were stored there for different lengths of time, typically ranging from a few hours to several weeks. A gradual reduction in the moisture content of the media was found to occur over time. The moisture content of each droplet was determined gravimetrically from the difference in the droplet weight before and after drying, and was expressed as a percentage of anhydrous dry weight. Anhydrous dry weights were determined by baking a representative droplet overnight at 110° C. and measuring the droplet weights. At defined times, a cover slip containing a droplet was removed from the drying environment and rehydrated by adding 100 microliters of pre-conditioned (37° C.) culture medium to the droplet to recover and rehydrate the cells. The cells within the droplet were then cultured overnight (˜18 h) and assessed for viability.

Convective flow drying under dried nitrogen was used to increase the drying rate in some cases. The convective flow drying protocol is as follows. The cover slips containing the cells were placed in a laminar flow chamber, and nitrogen gas, dried by passing the gas through a desiccating column containing CaSO₄/CaCl₂ desiccant, was passed over the cover slips. The linear flowrate of nitrogen gas within the chamber was about 100 cm/min and the cross-sectional area of the chamber was 45.72 cm across by 2.54 cm high. The slides were dried for between 5-90 min. At defined times, a cover slip containing a droplet of cells was removed from the drying environment, rehydrated, and assessed for viability, as described above.

The integrity of the plasma membrane of the cells after rehydration was determined using a dual fluorescent assay as follows. SYTO® 13 (Molecular Probes, Inc. Eugene, Oreg.), a permeant live cell nucleic acid dye (25 micromolar), and ethidium bromide (EB; 25 micromolar) were used to differentially stain the cells. The cells were imaged on a fluorescent microscope and analyzed. The membrane integrity (MI) for the cells was calculated as the percentage of SYTO® 13-positive cells in the sample.

Following overnight culture, the percentage of viable cells in droplets that were dried and then recovered, compared to undried controls, was used as a measure of cell growth. Viable fibroblasts could be readily identified through their flattening, migratory, and mitotic behavior. By normalizing to undried controls, the percentage growth values not only represented the number of cells capable of adhering to the glass substrate after drying and recovery, but also accounted for cells that had divided during post-rehydration culture. Thus, for a percentage growth value that is near 100%, the recovered cells would attach and divide at a rate similar to that of the undried control cells.

### EXAMPLE 2

In this example, 3T3 murine fibroblast cells stored in a dried state in a hypertonic solution were recovered and analyzed to determine their viability, using tests for plasma membrane integrity and the ability of the fibroblasts to grow and divide in post-rehydration culture. In these experiments, cells loaded with internal trehalose and dried in external trehalose showed higher MI values after drying than cells without internal trehalose.

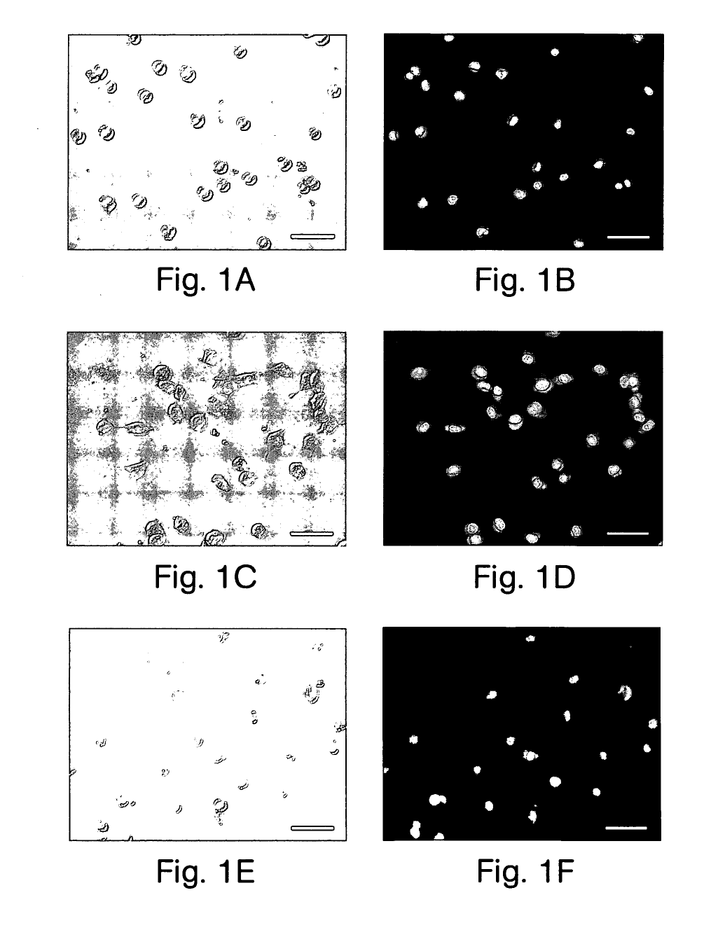

Following reversible poration with H5 alpha-hemolysin and the insertion of intracellular trehalose into the fibroblasts using methods similar to those described in Example 1, the fibroblasts attached to the glass cover slips were observed to have intact membranes and a spherical morphology (FIGS. 1A and 1B; scale bar represents 50 micrometers). The cells were dried using convective drying techniques (see Example 1).

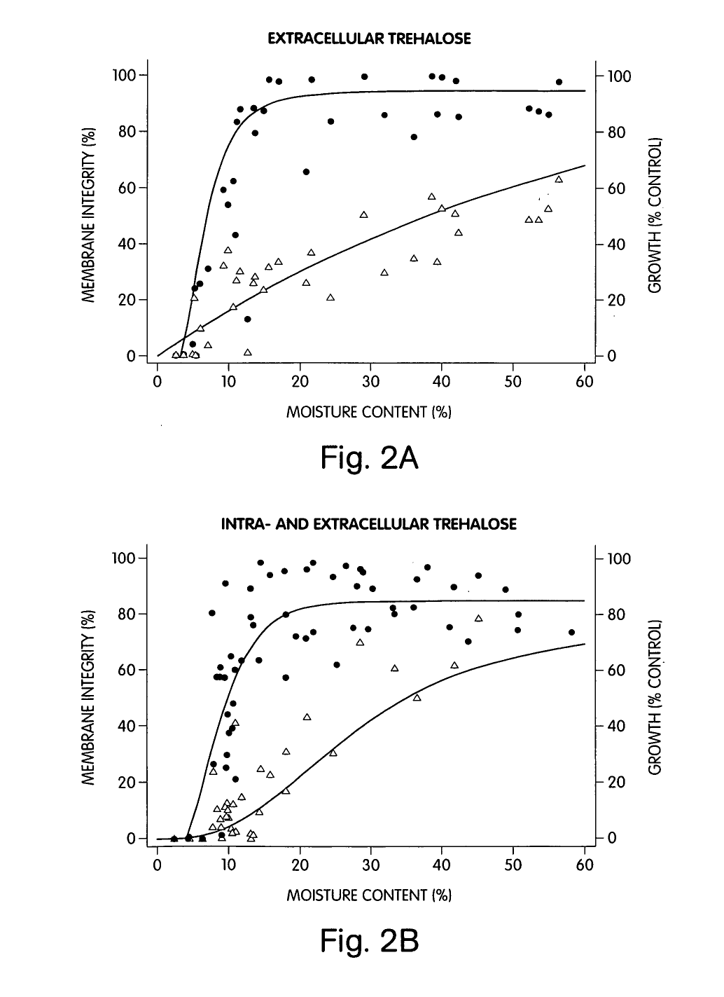

The fibroblasts were exposed to a 528 mOsm/kg (hypertonic) solution of 0.2 M intracellular and/or extracellular trehalose and were desiccated by natural convection at ambient temperature and assessed following rehydration and overnight culture. After drying and recovery, healthy viable fibroblasts will visually have an intact plasma membrane and will assume a flattened morphology when cultured on glass cover slips (FIGS. 1C and 1D). In contrast, non-viable cells will remain rounded and will display significant membrane damage following rehydration and overnight culture (FIGS. 1E and 1F). The post-rehydration MI and percent growth of 3T3 fibroblasts following exposure to a hypertonic solution of intracellular and/or extracellular trehalose was found in these experiments to depend on the moisture content achieved during drying (FIG. 2). In FIG. 2, cell membrane integrity is indicated as closed circles, and cell growth after recovery is indicated as open triangles (the curve fits in FIG. 2 are rough visual guides and do not represent a numerical model).

With decreasing moisture content, in hypertonic solution, the membrane integrity was observed to remain relatively stable for moisture contents greater than about 15% for cells stored with extracellular trehalose only, and greater than about 10% in cells stored in the presence of intracellular and extracellular trehalose. Fewer intact cells were recovered following drying to less than 5% moisture content in the presence of hypertonic solutions of 0.2 M intracellular or extracellular trehalose.

Concerning cell growth, decreasing the moisture content of the cell samples by convective drying resulted in a decreasing percentage of cells that were capable of growth following rehydration, a measure of viability (FIG. 2). In the presence of hypertonic trehalose solutions, there was a gradual decay in the percentage of cells capable of assuming a flattened morphology following culture after rehydration. Less than 20% of the cells were viable following drying to about 10% moisture content. In the presence of hypertonic trehalose solutions, cell growth was consistently lower than the membrane integrity at all moisture contents studied.

### EXAMPLE 3

In this example, the effect of drying cells in an isotonic trehalose solution, in accordance with an embodiment of the invention, is illustrated.

An isotonic cell storage solution was prepared by diluting an RPMI-1640 solution with distilled water such that the osmolality of the intracellular and extracellular solutions containing 0.2 M trehalose was reduced to 310 mOsm/kg. 3T3 murine fibroblasts prepared according to the methods discussed in Example 1 were exposed to the isotonic cell storage solution, then convectively dried over desiccant at room temperature and stored overnight (i.e., for about 18 h). After storage, the cells were recovered, and the MI and percentage growth were assessed, using techniques similar to those described in Examples 1 and 2.

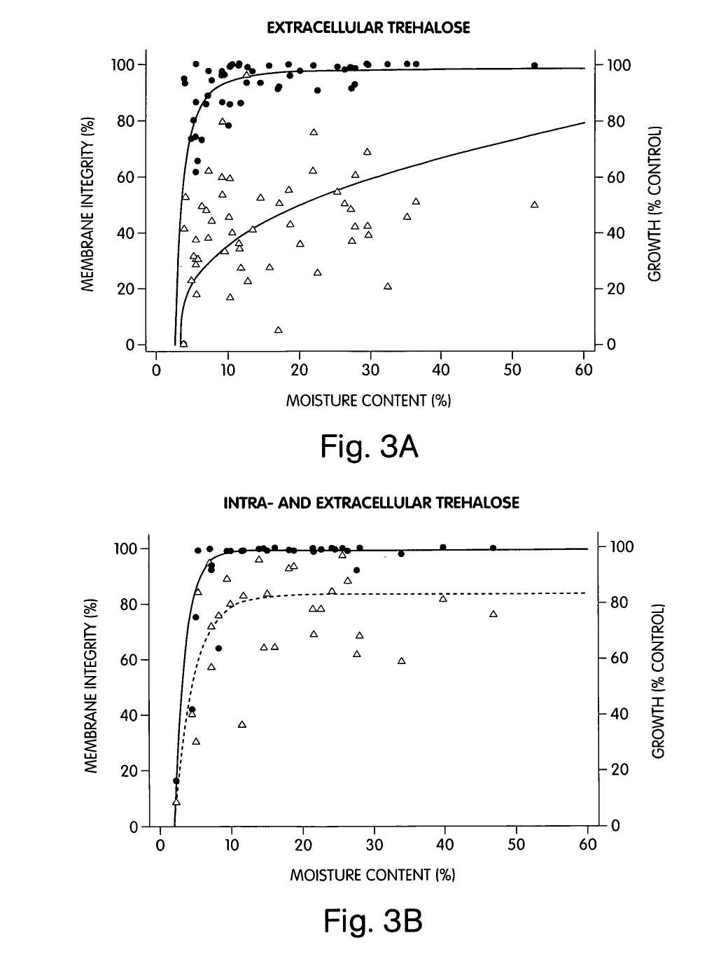

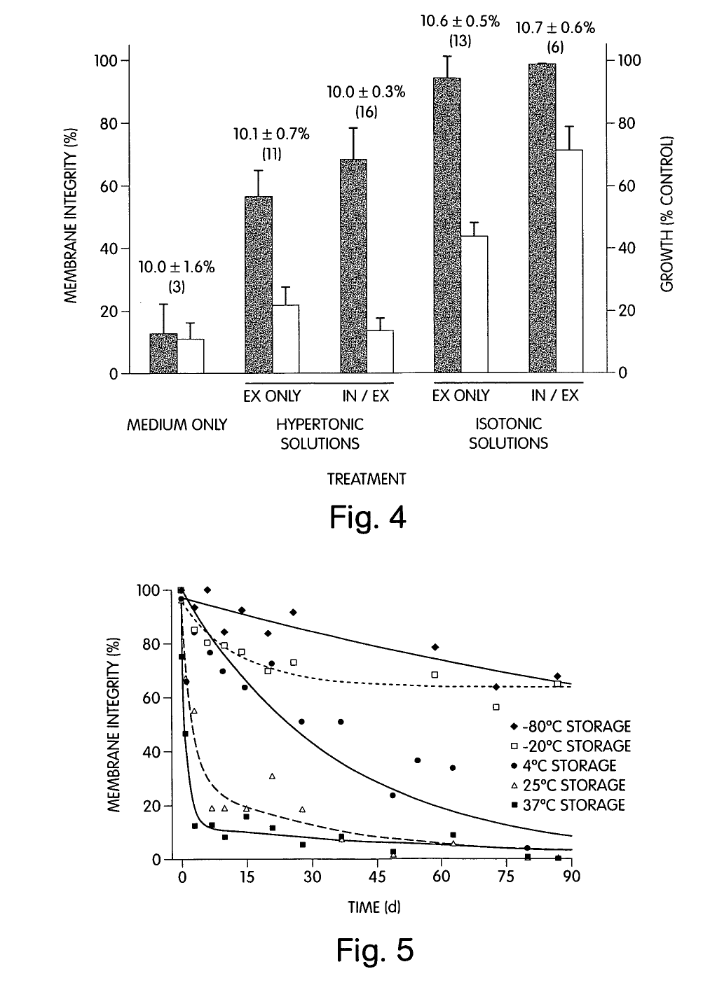

The plasma membrane of 3T3 fibroblasts in isotonic solutions of 0.2 M trehalose was found to remain relatively intact during drying, as illustrated in FIG. 3. Gross membrane damage was not observed until the cells were dried below about 5-8% moisture content. In FIG. 3, the cell membrane integrity is indicated as closed circles and cell growth after recovery as open triangles. The curve fits are rough visual guides and do not represent a numerical model. Drying to about 10% moisture content resulted in an approximately equal percentage MI for cells dried in extracellular trehalose only, and cells dried in the presence of intracellular and extracellular trehalose. A summary of this data can be seen in FIG. 4, compared to similar experiments where the cells were stored in hypertonic solutions. The membrane integrity data are indicated as solid bars and cell growth data as grey bars.

The next-day growth of cells dried in isotonic solutions of 0.2 M extracellular trehalose was found to gradually decline with decreasing moisture content (FIG. 3A). While the MI of these cells remained stable during drying to 10% moisture content, the percentage of cell growth dropped to less than about 30% at this moisture level. Some cells were also found to be capable of growth following desiccation to moisture contents that were less than 5%.

In contrast, the growth of cells dried in the presence of intracellular and extracellular isotonic (0.2 M) trehalose solution was found to be very stable during drying (FIG. 3B). Approximately 80% of the cells dried to moisture contents greater than about 10% were capable of growth after recovery and overnight culture. Thus, solutions of isotonic intracellular and extracellular trehalose were found to have provided a significant improvement in the percentage of cell growth of cells dried to about 10% moisture content, compared to isotonic extracellular trehalose only (FIG. 4; p=0.004).

Post-rehydration membrane integrity was determined to be a function of the moisture content of the fibroblasts following drying, and during storage. Cells loaded and dried in both hypertonic and isotonic solutions of 0.2 M trehalose were shown to have intact membranes at relatively high moisture contents (compare FIG. 3 to FIG. 2). Continued drying of the fibroblasts cells in intracellular and/or extracellular hypertonic trehalose below about 15% moisture content resulted in some decreases in membrane integrity, although recovery of cells was still demonstrated. However, in contrast, cells dried in isotonic trehalose solutions remained intact (MI) below about 15% moisture content, with a high degree of intact cells (about 80%) at moisture contents as low as 5-8%, and some recovery of dried cells was demonstrated even at lower moisture contents. Thus, in these experiments, for fibroblasts dried to such low moisture contents, reducing the initial osmolality and tonicity of the trehalose solution by diluting the solvent appears to provide improved protection of the plasma membrane during drying and subsequent recovery.

Thus, isotonic solutions can help to protect cells during drying by minimizing dehydration damages and stresses to intracellular structures and organelles. While the plasma membrane is often the site of damage identified during freezing and drying-induced dehydration, other cell structures and organelles have also been shown to be sensitive to hypertonic stress, including the cytoskeleton, mitochondria, lysosomes, and the nucleus. As the plasma membrane can be stabilized during dehydration using intracellular and/or extracellular sugars, mammalian cells can be dried to fairly lower moisture contents, before membrane rupture occurs (loss of membrane integrity). The lower moisture contents also correspond with a higher degree of cell shrinkage and intracellular concentration of solutes. As shown in FIGS. 2A and 3A, the cells in isotonic solution appeared to shrink less than the cells dried in hypertonic solution. At a given moisture content, the intracellular concentration of solutes was found to be lower in cells dried in isotonic extracellular trehalose than in cells dried in hypertonic extracellular trehalose.

In conclusion, these experiments have shown that fibroblasts dried in isotonic trehalose solutions were capable of growth following substantial desiccation and recovery.

### EXAMPLE 4

This example demonstrates the long-term stability of the plasma membrane in accordance with an embodiment of the invention.

The membrane integrity of 3T3 fibroblasts loaded with 0.4 M trehalose intracellularly was measured for periods of time extending out to several weeks (FIG. 5). The fibroblasts were prepared using methods similar to those described in Example 1. The data in FIG. 5 represents experiments where cells were removed from storage, rehydrated, analyzed, and then discarded. The cells were stored at temperatures of −80° C., −20° C., 4° C., 25° C., and 37° C., over CaSO₄ desiccant (about 5% relative humidity). The 0.4 M trehalose condition was chosen in this example since previous experiments had shown that cells containing 0.4 M trehalose had high MI values after overnight storage.

During storage at 4° C., the integrity of the plasma membrane of the fibroblasts was found to stay relatively high, even after several weeks. Thus, under these relatively benign and easily achievable storage conditions, the plasma membrane of mammalian cells was found to be preserved in an intact state for several weeks. Assuming an exponential decay of MI over time, the decay time constant was found to be 147, 138, and 54 days for storage at −80° C., −20° C., and 4° C., respectively, as determined by curve fitting (see FIG. 5). In contrast, at a storage temperature of 25° C., the time constant of decay was found to be 7.5 days, while at 37° C., the time constant was 2.0 days. Thus, the rate at which the membrane integrity decays appears to be a function of the storage temperature.

The extracellular trehalose solutions containing the cells were observed to reach the glass state and reach their final moisture contents within the first day of the experiment, as determined by modulated temperature differential scanning calorimetry and gravimetric analysis (data not shown). The glass transition temperature of the extracellular trehalose concentration was found to be about 5 to 10° C. after 18 h of dried storage at 4° C. Thus, the extracellular trehalose solution had vitrified by 18 h. After vitrification (glass formation) of the solution containing the cells had occurred, the cells were able to retain their plasma membrane integrities, even after days to weeks in storage at relatively cooler storage temperatures.

### EXAMPLE 5

In this example, Western blot analysis was used to determine the mitochondrial response of cells to desiccation. In these experiments, human fibroblasts (WS1 cells) were desiccated in the presence of 0.2 M extracellular trehalose to about 14% moisture content, then recovered and cultured, using methods similar to those in Example 1. During drying, samples of cells were collected at various time points and analyzed as follows. Proteins were extracted from the cells and analyzed for the initiation of an apoptotic response by the mitochondria to the drying process using standard Western blot analysis.

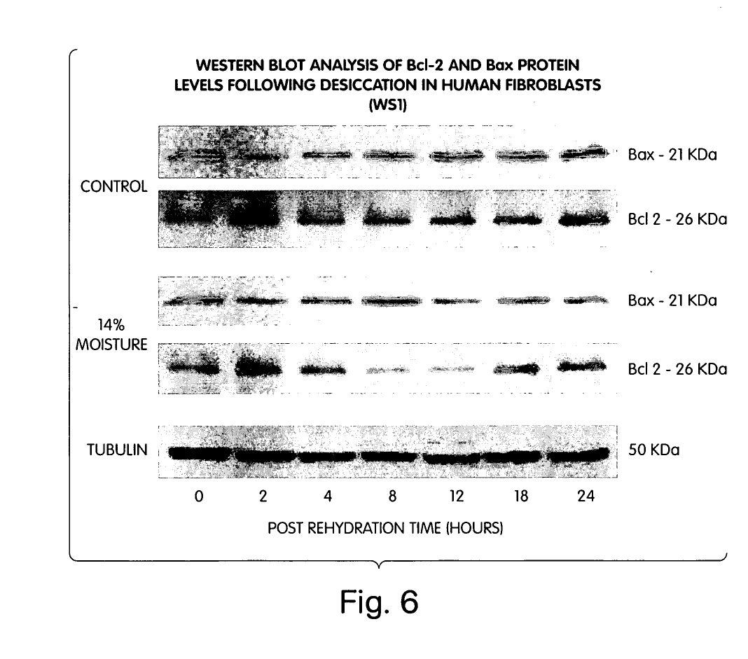

In these experiments, an increase in the level of Bax protein (a pro-apoptotic indicator), starting from around 8 hours, was observed, as shown in FIG. 6. The increase in Bax protein may indicate an increase in cell death signaling within the cells during drying. In addition, a decrease in the level of Bcl-2 protein (an anti-apoptotic indicator) at 8 hours was observed, which may indicate that there was a decrease in the “survival” signal in the cell during drying. In conjunction with the pro-apoptotic or “pro-death” Bax protein signal, these results collectively suggest that, during desiccation, the WS1 cells have a propensity to undergo apoptotic cell death during drying.

### EXAMPLE 6

In this example, human hepatic cells (C3A cells) were dried and studied to determine changes in apoptosis markers, and the effects of apoptosis inhibitors, during drying.

In these experiments, C3A cells were desiccated under vacuum at room temperature in the presence of 0.2 M extracellular trehalose to various moisture contents, then rehydrated, placed into culture and assessed for viability about 24 hours later. Cell samples were collected at various time points during each experiment. Proteins were extracted from the cell samples and analyzed for the initiation of an apoptotic response by the mitochondria. The protocols used in these experiments were similar to those described in Example 1.

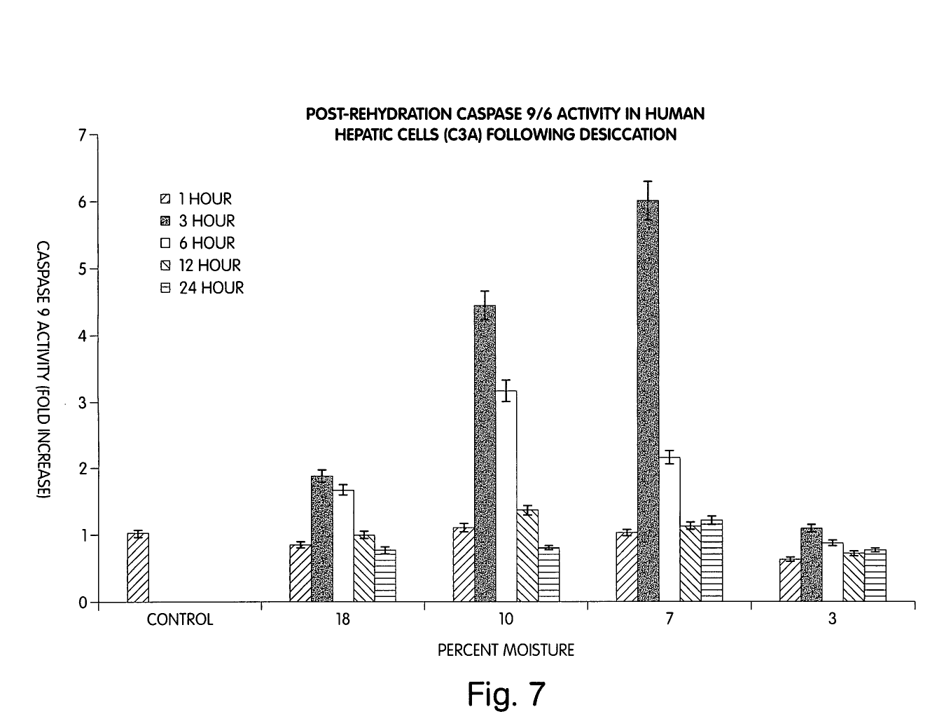

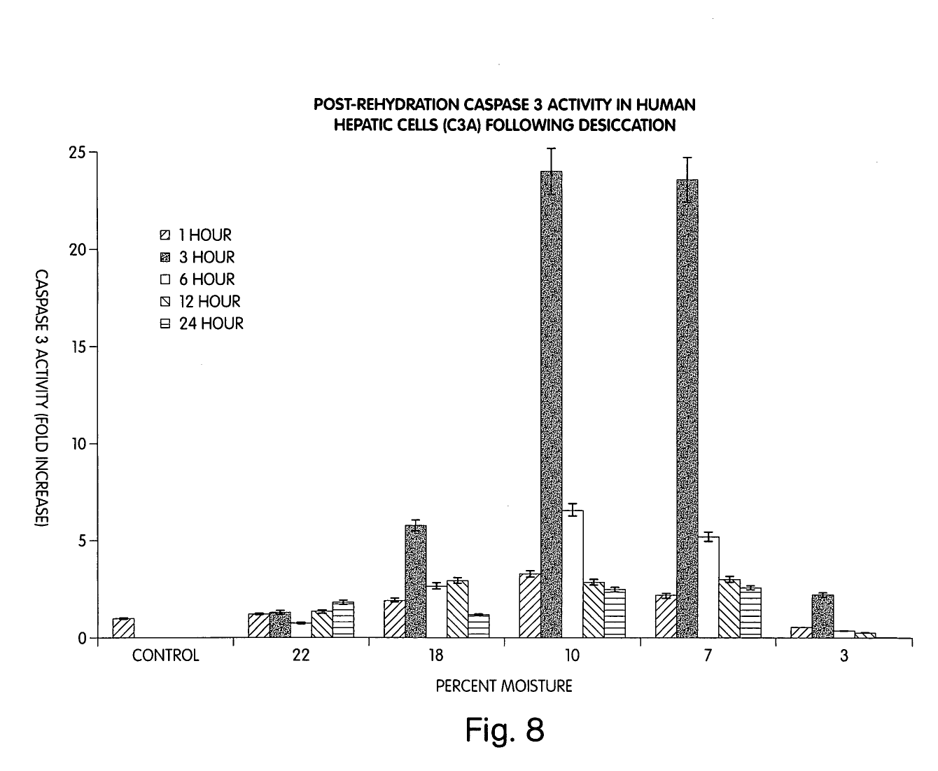

FIG. 7 shows the analysis of the apoptotic proteases Caspases 9 and 6 in the C3A experiments. Caspases 9 and 6 are associated with the signal transduction of mitochondrial-induced apoptosis activity. Similarly, in FIG. 8, the analysis of the apoptotic protease Caspase 3, an executioner protease involved with downstream cellular disassembly in the final termination stages of apoptosis, is illustrated for C3A cells. In these experiments, an increase in caspase activity was observed, peaking at roughly 3 hours after cell rehydration. In addition, a significant increase in caspase activity was found with increasing drying, as the extent of cellular desiccation during drying appeared to increase to a point at which the primary mode of cell death switches from apoptotic to necrotic cell death.

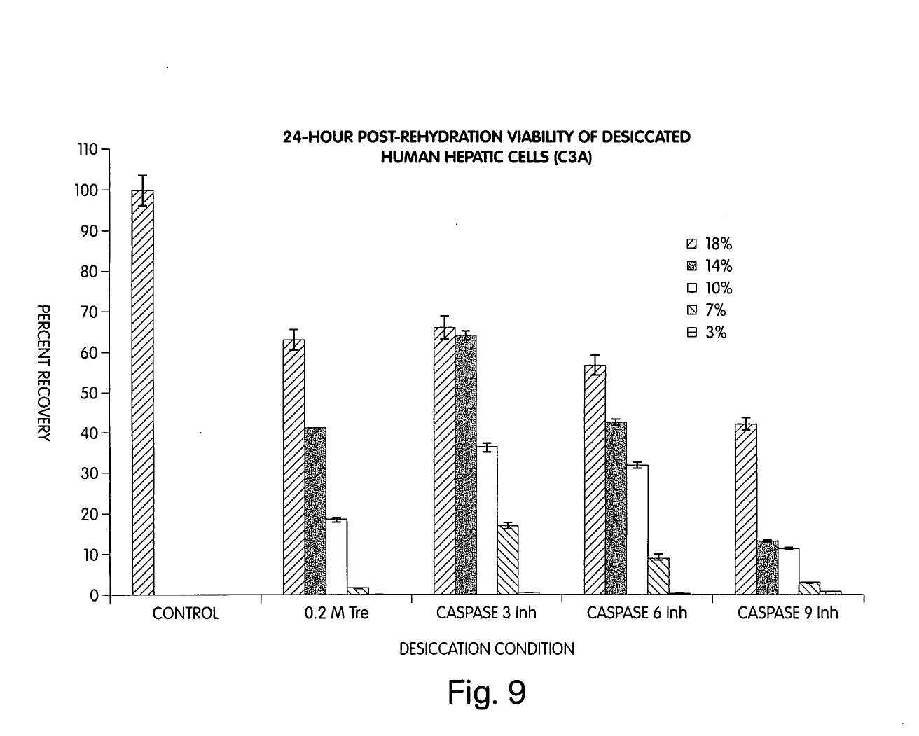

Various apoptosis and other inhibitors were also used to modulate the apoptotic response following desiccation. Some of these effects are shown in FIG. 9. In these experiments, C3A cells were desiccated in the presence of 0.2 M extracellular trehalose, with and without Caspase 3, 6, or 9 inhibitors, to various moisture contents. The C3A cells were then recovered by rehydrating them and placing them into culture, and assessed for viability about 24 hours later.

In general, as shown in FIG. 9, a loss of cell viability was observed as the moisture content of the cell decreased. In samples desiccated with 0.2 M trehalose with caspase inhibitors, an increase in cell viability in cells exposed to Caspase 3 and Caspase 6 inhibitor samples were observed. This effect is especially notable for cells at 14, 10, and 7% moisture contents.

### EXAMPLE 7

In this example, the effect of a substrate on cell viability during and/or following drying was studied.

In this set of experiments, human fibroblast cells (HFF1 cells) were desiccated under vacuum at room temperature on various surfaces, and in some cases, in the presence of 0.2 M extracellular trehalose. The fibroblasts were dried to about 20% moisture content. The fibroblasts were then recovered by rehydrating them, placing them into culture, and assessing their viability about 24 hours later, using techniques similar to those described in Example 1.

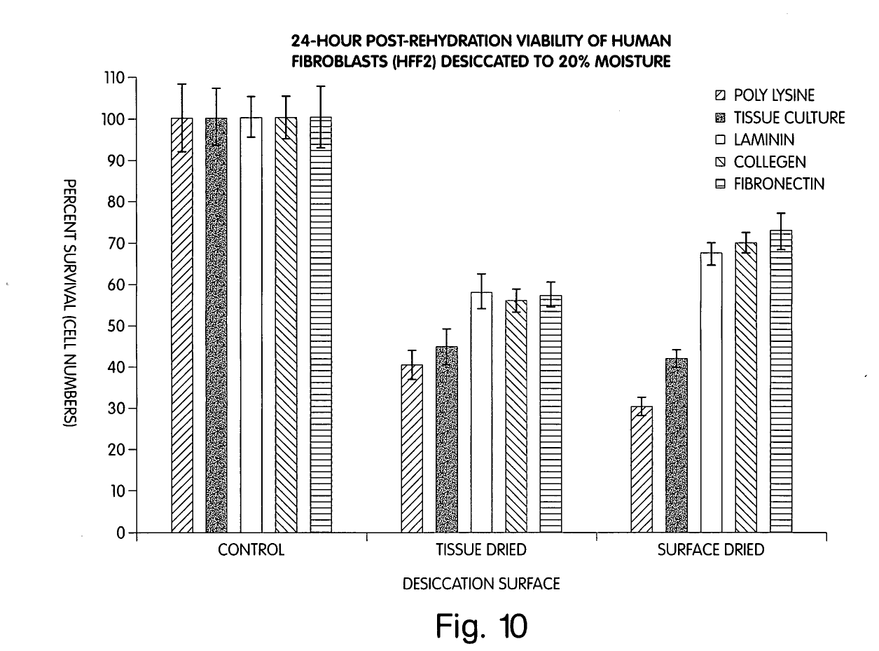

Increases in cell viability were observed following drying of the cells on standard tissue culture surfaces, followed by post-rehydration of the cells on cell adhesion surfaces coated with collagen, fibronectin, or laminin as respectively indicated by the “Tissue Dried” data in FIG. 10. Furthermore, significant enhancements in cell viability were observed when the cells were dried and cultured on the cell adhesion surfaces, indicated by the “Surface Dried” bars.

### EXAMPLE 8

In this example, a convective drying system was used to achieve controlled drying of mammalian cells.

FIG. 11 shows a schematic for a representative convective drying setup in accordance with one embodiment of the invention. A dry non-oxidative gas (nitrogen in this example) from a pressurized cylinder was blown through a chamber designed to hold a glass microslide having a 20 microliter cell droplet placed on it. The microslide had two etched rings, 10 mm in diameter, that ensured reproducible droplet positioning for successive drying protocols. The flow of nitrogen was controlled by a calibrated flowmeter placed at the entrance of the flow chamber. The entire flowpath and the flow chamber were tightly sealed to prevent leakage of gas, and to ensure reproducible drying conditions. This convective drying setup, shown in FIG. 1, was then used to develop controlled drying protocols such as those previously discussed.

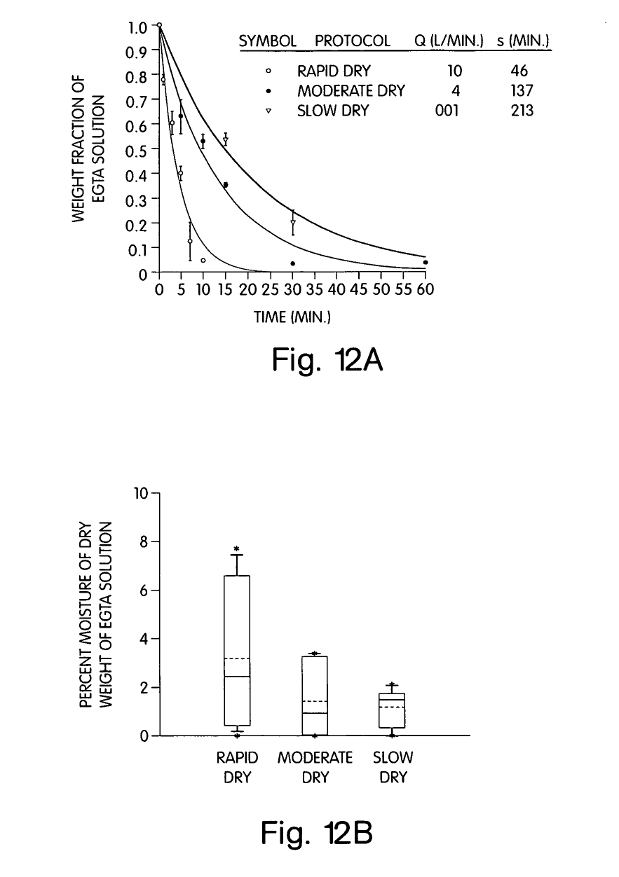

As an example, in FIG. 12, the drying kinetics for an EGTA supplemented Tris-HCl buffer used for sperm isolation is shown. Different drying rates, (“rapid,” “moderate,” and “slow” conditions indicated in the inset) were generated by appropriately setting the flowmeter and the associated equipment. These drying curves were then used to produce reproducible final moisture contents within the cell droplets. For instance, FIG. 12B shows the spread in data of controlled drying of the EGTA solution for 10 minutes using the “rapid” drying protocol, 30 minutes using the “moderate” drying protocol, and for 60 minutes using the “slow” drying protocol, where each protocol was used to obtain an average moisture content of less than 5%.

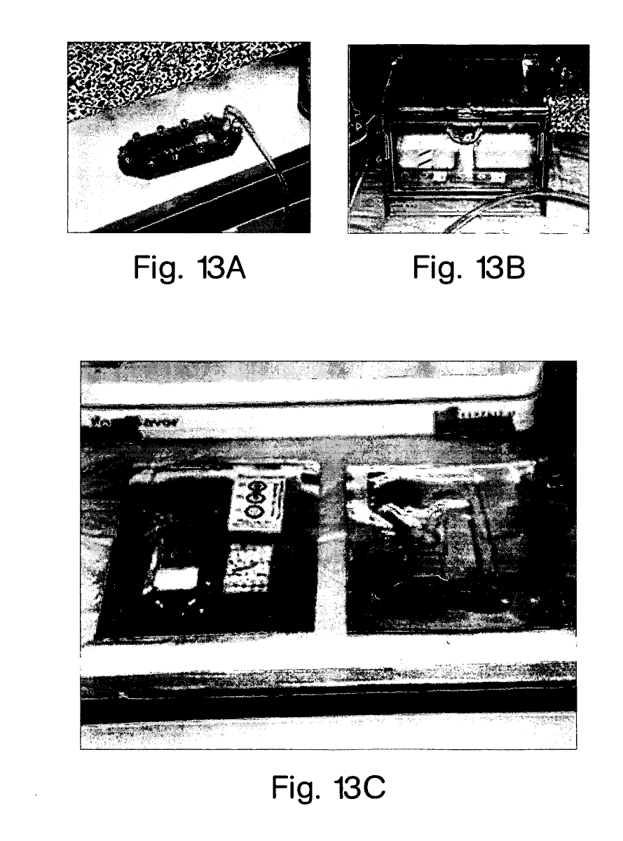

Similar results to those described in association with FIG. 12 has been generated for various other drying solutions, and for various other cell types. For instance, this method has been used to reproducibly dry cells to various moisture contents (e.g., to 20% moisture, to 10% moisture, etc.) with a variance in moisture content of less than about 5% (data not shown). Additionally, the system described in this example were adapted for evaporative drying techniques (e.g., as described in Example 1). Using suitable desiccants, any moisture contents of between 0 and 100% were selected as desired. An example of such a system is shown in FIG. 13B.

Thus, this example illustrates a simple and cost-effective setup that was used to perform certain convective drying protocol, producing reproducible results.

### EXAMPLE 9

In this example, the packaging of dried mammalian cells is illustrated in accordance with one embodiment of the invention.

After drying the cells using techniques similar to those described in Example 8, silicone isolators (0.5 mm depth and 10 mm diameter) were used as spacers. Silicone isolators were chosen for this example because of their ability to be easily attached to glass slides with minimal air gaps therebetween. After attaching two silicone isolators, a glass cover slide was placed on top of the silicone. This allowed an airtight system to be created, which allowed only minimal losses of moisture. Afterwards, the glass slide-silicone isolator assembly was placed in a moisture-resistant vacuum bag, and vacuum packed using a conventional vacuum sealer, ensuring a substantially airtight system.

In some cases, the vacuum-sealed bags were then placed within an oxygen-resistant bag, and vacuum sealed therein. The oxygen-resistant bag was made out of a material that allows only minimal oxygen diffusion therethrough. In some cases, opaque bags were also used that were also able to prevent exposure of the system to light, which can cause additional oxidative or other damage to the cells. Furthermore, oxygen absorbers were placed in the bags before vacuum sealing in some experiments to prevent any oxygen within the bag from diffusing into the inner sealed bag containing the cells. In certain experiments, a color humidity indicator was also used to give a visual indicator of the relative humidity within the bag when the bag was sealed. In these experiments, when the bag was opened, the color humidity indicator gave a visual indication of the humidity within the bag, allowing the experimenter to know whether the packaging and storage of the bag had been properly performed.

While several embodiments of the invention have been described and illustrated herein, those of ordinary skill in the art will readily envision a variety of other means and structures for performing the functions and/or obtaining the results or advantages described herein, and each of such variations or modifications is deemed to be within the scope of the present invention. More generally, those skilled in the art would readily appreciate that all parameters, dimensions, materials, and configurations described herein are meant to be exemplary and that actual parameters, dimensions, materials, and configurations will depend upon specific applications for which the teachings of the present invention are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described. The present invention is directed to each individual feature, system, material and/or method described herein. In addition, any combination of two or more such features, systems, materials and/or methods, if such features, systems, materials and/or methods are not mutually inconsistent, is included within the scope of the present invention.

In the claims (as well as in the specification above), all transitional phrases such as “comprising,” “including,” “carrying,” “having,” “containing,” “involving,” and the like are to be understood to be open-ended, i.e. to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method, comprising:
inserting a non-permeating agent into a nucleated cell without using microinjection;
drying the cell to a moisture content of less than about 30%; and
storing the cell, in a substantially constant environment, such that the cell is recoverable in a viable state.

2. The method of claim 1, wherein the inserting step comprises applying a pore-forming agent to the cell.

3. (canceled)

4. The method of claims 1, wherein the non-permeating agent comprises a carbohydrate.

5. The method of claim 4, wherein the carbohydrate comprises a disaccharide.

6. The method of claim 4, wherein the disaccharide comprises trehalose.

7-8. (canceled)

9. The method of claim 1, further comprising exposing the cell to a cell death inhibitor.

10. The method of claim 1, further comprising exposing the cell to an oxidative stress modulator.

11. The method of claim 1, further comprising forming a glass internally of the nucleated cell.

12-13. (canceled)

14. The method of claim 1, further comprising forming a glass externally of the nucleated cell.

15-17. (canceled)

18. The method of claim 1, wherein the drying step comprises drying the cell to a moisture content of less than about 20%.

19-23. (canceled)

24. The method of claim 1, wherein the storing step comprises storing the cell at a temperature less than the cell glass transition temperature.

25-27. (canceled)

28. The method of claim 1, wherein the storing step comprises storing the cell in an environment having a substantially saturated relative humidity.

29-34. (canceled)

35. An article, comprising:
a glass having a temperature less than about 37° C., the glass comprising a cell and a cell death inhibitor.

36. The article of claim 35, wherein the glass comprises a carbohydrate.

37-40. (canceled)

41. The article of claim 35, wherein the cell has a moisture content of less than about 30%.

42. The article of claim 35, wherein the cell is recoverable in a viable state.

43-49. (canceled)

50. The article of claim 35, wherein the glass further comprises an oxidative stress inhibitor.

51. An article, comprising:
a dried cell; and
an oxygen-resistant membrane in fluidic communication with the cell.

52. The article of claim 51, wherein the cell is recoverable in a viable state.

53-58. (canceled)

59. The article of claim 51, wherein the cell is contained within a glass.
